(19) United States
(12) Patent Application Publication
(10) Pub. No.: US 2026/0336374 A1
(43) Pub. Date: Oct. 29, 2026

(54) RANGE EXTENDED ELECTRIC AXLE HAVING INDEPENDENT SUSPENSION

(71) Applicant: Allison Transmission, Inc., Indianapolis, IN (US)

(72) Inventor: Shaun Mepham, Clarkston, MI (US)

(73) Assignee: Allison Transmission, Inc., Indianapolis, IN (US)

(21) Appl. No.: 19/654,692

(22) Filed: Apr. 22, 2026

Related U.S. Application Data
(60) Provisional application No. 63/795,935, filed on Apr. 28, 2025.

(51) Int. Cl. B60K 1/00; B60G 3/20; B60G 15/06

(52) U.S. Cl. CPC B60K 1/00; B60G 3/20; B60G 15/062; B60G 2200/144; B60K 2001/001

(57) ABSTRACT

A vehicle system includes an electric axle and a cradle. The electric axle includes an e-machine and a transmission. The cradle supports the e-machine and the transmission when mounted to a vehicle. The electric axle further includes a suspension in the form of an independent suspension that is coupled to the cradle. In one form, the suspension includes a lower suspension arm and an upper suspension arm, and the lower suspension arm and the upper suspension arm are pivotally coupled to the cradle. a damper connected between the lower suspension arm and the cradle, and a spring is disposed between the lower suspension arm and the cradle.

### CROSS REFERENCE TO RELATED APPLICATIONS

This application claims the benefit of U.S. Patent Application No. 63/795,935, filed Apr. 28, 2025, which is hereby incorporated by reference.

### BACKGROUND

Military vehicles as well as other types of vehicles, such as sport utility vehicles (SUVs) and trucks, commonly require off-road capabilities and need to operate under extreme conditions. In off-road conditions, ground clearance is always a concern. An errant rock or mud may cause the vehicle to become stuck. Moreover, such vehicles need to be constructed to survive even the harshest conditions.

Thus, there is a need for improvement in this field.

### SUMMARY

A vehicle with a unique powertrain system has been developed to address the above-mentioned as well as other issues. The powertrain system includes a unique electric axle or e-axle that is configured to move the vehicle. The electric axle has an independent suspension that allows the vehicle to efficiently move across even the toughest terrains. In some cases, the electric axle is able to propel the vehicle at seventy miles-per-hour (70) or greater, and the electric axle is able to move the vehicle up a sixty percent (60%) grade or greater. The electric axle is further able to operate even under the harshest conditions. In one example, the electric axle includes a sump guard to protect the sump of the electrical axle from rocks or other debris. When used in military vehicles, it is envisioned that the electric axle may further include shielding that is configured to absorb and/or redirect the force of projectiles or, in some rare cases, an explosion, such as from an improvised explosive device (IED), away from one or more key components of the electric axle such that the electric axle is still able to operate. For instance, the electric axle in some versions includes side, front, and/or rear projectile plates to protect at least some key components of the electric axle from projectiles like bullets.

The electric axle is constructed to be modular in nature so that the electric axle can be readily adapted for use in a wide variety of vehicle configurations. For instance, the electric axle in one version is incorporated into a series type hybrid vehicle. As should be recognized, at least some components of the electric axle can be adapted for use in series hybrid vehicles, parallel hybrid vehicles, series-parallel hybrid vehicles, or battery electric vehicles (BEVs), to name just a few examples. In one version, one or more electric axles are installed at the axle locations of a series hybrid type vehicle. The vehicle includes a chassis, an internal combustion engine mounted to the chassis, and an electric generator connected to the engine. In some versions, one or more spring friction dampers are disposed between one or more generators and the engine. The vehicle has a fuel tank mounted to the chassis that supplies fuel, like diesel fuel or gasoline, to power the internal combustion engine. The vehicle further has an energy storage system (ESS), such as in the form of a battery pack, that is configured to store energy. The vehicle includes one or more of the electric axles that are mounted to the chassis. For example, the system can be extended where the electric axles are mounted on 4×2, 4×4, 6×2, 6×4, 6×6, 8×2, 8×4, 8×6, 8×8, 10×2, 10×4, 10×6, 10×8, and 10×10 type vehicles. The system has been laid out and designed so that the axle module mounting frame can be modified into the vehicle front clip or mounted directly to the underside of a conventional chassis. In such cases, the chassis rails are designed for frontal crash stiffness, and cross braces are used for vehicle torsional stiffness.

The modular nature of the electric axle allows the electric axle to be installed at a single axle of the vehicle or on multiple axles of the vehicle. In other words, the electric axle is able to scale with the size of the vehicle. For instance, the electric axle in one version is installed on a single axle of a light duty vehicle. In a further version, the vehicle has two (2) electric axles. In still yet other versions, each of the five (5) axles of a common tractor-trailer design includes the electric axle. In some cases, the same vehicle can incorporate eight (8) or more electric axles. It should be recognized that the number of electric axles on a vehicle can vary depending on a number of factors such as the size and power requirements of the vehicle. Having the electric axle powering multiple axles can be helpful in defense environments, because it can enhance overall survivability of the vehicle. For instance, when one or more of the subsystems of the vehicle fail, the other parts of the electric axle system can compensate so that the vehicle is able to maintain mobility. In other words, the vehicle can limp home even if one of the electric axles is inoperative. Through regenerative braking and other capabilities provided by the electric axle, the range of the vehicle can be extended as compared to conventional internal combustion engine configurations. When operating under constant stop-start conditions or locations, the system is able to optimize fuel consumption by allowing the engine to always operate in a more efficient operational range as long as the battery has enough charge rate capacity after delivering the traction power.

In one particular version, the vehicle is a series hybrid with twin independent electric axles. It was found that this configuration had a higher failure tolerance. In other words, even if some failures in the vehicle powertrain occurred, the vehicle was still able to operate. For instance, if one of the electric axles fails, the other electric axle is able to compensate for the loss such that vehicle is still able to operate. In another example, if the battery fails, the engine and the generators are still able to provide power, and if the engine fails, the battery is able to provide electrical power to one or more electric axles so that the vehicle is still mobile. The twin independent axles further increase the range of the vehicle for the same fuel load. While still meeting the most challenging operational requirements, the design further is able to incorporate preexisting hardware. As alluded to before, the system is still able to optimize brake specific fuel consumption (BSFC) even for preexisting hybrid vehicle designs.

The modular electric axle can function as purely a drive axle that transmits power to the wheels or as a steering axle that is able to turn the wheels in order to steer the vehicle. In other words, each electric axle is capable of providing drive power to the wheels and/or steer the wheels of the vehicle. Even when acting as a steering axle the electric axle can provide power to the wheels, and in other cases, the electric axle may not provide power to the wheels when acting as a steering axle. For instance, the electrical axle can be used solely for regenerative braking purposes to recharge the ESS on the vehicle (or not). In one version, the electric axle has the ability to select neutral for at least two conditions. One of these conditions occurs for example when the driving surface has high traction, and in such a high traction condition, it is more efficient to only have the losses on one electric axle. By having at least one of the electric axles in neutral removes the inertia of the electric machine of the electric axle in neutral from the driveline. The second condition can occur during braking with an anti-lock braking system (ABS). During an ABS braking event, the motor is separated from the driveline to allow the ABS to have full control of the wheel. The modular nature of the electric axle further allows electric axles to be easily swapped out or replaced with others. This modular nature of the electric axle can be helpful in combat or other military defense situations when damage occurs. In other words, the modular system facilitates fast turnaround repairs. For example, the damaged electric axle can be entirely replaced or fixed with parts scavenged from other electric axles.

In one version, each electric axle includes an inverter that is electrically connected to the ESS and/or the generator connected to the internal combustion engine. In one variation, each electric axle has a dedicated inverter to control wheel speed independently. In other variations, the inverter may be shared between the electric axles. In some variations, the electric axle further includes a projectile protection plate positioned to protect the inverter as well as other components of the electric axle. In some cases, the electric axle further has a flat shield or a V-shaped shield positioned between the electric axle and the driving surface to protect the electric axle from explosions or debris. The electric axle further includes an electric motor-generator or e-machine that is electrically coupled to the inverter and a transmission that is mechanically coupled to the e-machine. In one version, the transmission is a two-speed transmission that includes one or more planetary gears and clutches arranged along a parallel axis. The transmission in one form has a hydraulic shift actuator or an electrical shift actuator configured to shift the gears of the transmission.

The electric axle further includes a hydraulics system that is designed to operate even under extreme conditions. For instance, the hydraulics system in some cases is able to operate when the vehicle is at a 60% grade or even a higher grade. The hydraulics system is configured to circulate a hydraulic fluid, such as a lubricant, throughout the electric axle. Among other things, the circulated hydraulic fluid is used to lubricate and cool components within the electric axle such as the transmission and the electric motor. The hydraulics system includes the hydraulic shifter that is configured to shift the gears in the transmission. In one example, the hydraulics system has a differential lock piston that was shortened in order to fit within the tight constraints of the electric axle. Alternatively or additionally, the electric axle includes an internal hydraulic brake.

The hydraulics system further includes a sump tank, sump chamber, or sump area that collects the fluid. A sump guard is positioned proximal to the sump tank to protect the sump tank from being punctured such as by debris or from explosions. To facilitate operation of the vehicle at high grades, the hydraulics system includes a dry sump tank that facilitates low pressure circulation of the hydraulic fluid. The hydraulics system further includes one or more scavenger pumps that circulate the hydraulic fluid from the sump tank to the dry sump tank. To lubricate and cool various components, such as bearings and gears in the transmission, the hydraulics system of the electric axle includes a mechanical pump that is fluidly coupled to the dry sump tank. In some variations, the hydraulics system of the electric axle includes a hydraulic accumulator and one or more anti-vortex covers. In other forms, the hydraulic accumulator is a piston style accumulator or a bladder style accumulator.

The electric axle includes a unique cradle that mounts the inverter, the e-machine, and the transmission to the chassis of the vehicle. The cradle is secured to the underside of the chassis so as to simplify assembly of the vehicle as well as lower the center of gravity of the vehicle. The electric axle further includes a unique independent suspension that couples the wheels to the cradle of the electric axle. The independent suspension is designed to provide sufficient clearance so that the vehicle is able to clear even the most challenging obstacles. In one example, the suspension includes an upper suspension arm and a lower suspension arm that extend between the carriage and the wheel. The upper suspension arm and the lower suspension arm are each pivotally coupled to the cradle via one or more sealed suspension bushings. In one example, the upper suspension arm and the lower suspension arm are in the form of wishbone arms, but the suspension arms can be shaped differently in other variations. Between the upper suspension arm and the lower suspension arm, a drive shaft of the electrical axle extends to mechanically connect the wheel to the transmission. Via the drive shaft, the transmission is able to rotate the wheel.

The suspension further includes a spring and a damper or shock absorber. In one example, the damper and the spring are connected to and extend between the lower suspension arm and a mounting structure on the cradle. In one form, the spring is a helical coil spring that is wrapped around the damper to form a single unit or assembly. In other examples, the spring and the damper are separate components located at separate positions within the suspension. The spring can be configured differently in other variations. For instance, the spring in other variations is in the form of a torsion bar, and in still yet another variation, the spring is an air spring. The damper in one example is a hydraulic damper, but the damper can include other types of dampers. In one version, the electric axle is designed to provide active control of the vehicle ride height and/or control/prevent vehicle roll though fluid control within the axle system.

In most cases, the suspension further includes a stabilizer system and a steering system. The stabilizer systems is configured to reduce body roll of the vehicle during cornering as well as enhance overall handling and stability of the vehicle. In one example, the stabilizer system includes a sway bar or anti-roll bar. The anti-roll bar is coupled to the cradle, and the anti-roll bar extends across the electric axle to connect the suspensions at the opposing wheels of the electric axle. In particular, the anti-roll bar in one version has anti-roll arms located at opposing ends of the anti-roll arm. The anti-roll arms in one version are connected to the lower suspension arms via anti-roll drop links.

As noted before, the electric axle in some variations includes the steering system to facilitate steering. In some use cases, while present, the steering system is inactive such as when the electric axle is being used solely as a drive axle. In other cases, the steering system is used as a steer assist rear axle where one or more electric axles located at the rear of the vehicle are steered to reduce or otherwise enhance the vehicle turn radius. The steering system includes a steering crossbar with a load point. The cross bar extends between the independent suspensions for the opposing uprights of the electric axle. The steering crossbar is coupled to the upper steering arm via a steering input knuckle. The steering input knuckle can be driven by a conventional steering box, a solid link to the electric axle frame, an electric flyby wire steering actuator, or an electric-hydraulic flyby wire steering actuator.

The electric axle is able to readily accommodate different types or styles of brake systems so as to provide different performance capabilities depending on the needs of particular use cases. For example, the electric axle in one variation has an outboard located brakes where the brake disks and calipers are located proximal to the wheels. In other words, the brakes in the outboard configuration are located away from the transmission and cradle. The outboard located brakes are relatively easy to service. In another variation, the electric axle has inboard brakes that are positioned in or proximal to the cradle and the transmission. Having the brakes located at an inboard position provides greater protection for the brakes such as from explosions or debris. The inboard brakes also have a lower un-sprung weight that can enhance performance of the vehicle.

The systems and techniques as described and illustrated herein concern a number of unique and inventive aspects. Some, but by no means all, of these unique aspects are summarized below.

Aspect 1 generally concerns a system.

Aspect 2 generally concerns the system of any previous aspect including a vehicle.

Aspect 3 generally concerns the system of any previous aspect in which the vehicle is a hybrid vehicle.

Aspect 4 generally concerns the system of any previous aspect in which the vehicle is a serial type hybrid vehicle.

Aspect 5 generally concerns the system of any previous aspect in which the vehicle is a series electric range extended hybrid vehicle.

Aspect 6 generally concerns the system of any previous aspect including an engine.

Aspect 7 generally concerns the system of any previous aspect in which the engine is an internal combustion engine.

Aspect 8 generally concerns the system of any previous aspect including an electric motor.

Aspect 9 generally concerns the system of any previous aspect in which the electric motor is mechanically coupled to the engine.

Aspect 10 generally concerns the system of any previous aspect including an energy Storage System (ESS).

Aspect 11 generally concerns the system of any previous aspect in which the ESS is electrically coupled to the electric motor.

Aspect 12 generally concerns the system of any previous aspect including a chassis.

Aspect 13 generally concerns the system of any previous aspect in which the chassis includes a frame.

Aspect 14 generally concerns the system of any previous aspect in which the chassis has a body-on-frame construction.

Aspect 15 generally concerns the system of any previous aspect in which the chassis has a unibody construction.

Aspect 16 generally concerns the system of any previous aspect including an electric axle.

Aspect 17 generally concerns the system of any previous aspect in which the electric axle is coupled to the chassis.

Aspect 18 generally concerns the system of any previous aspect in which the electric axle includes a cradle.

Aspect 19 generally concerns the system of any previous aspect in which the cradle is connected to the chassis.

Aspect 20 generally concerns the system of any previous aspect in which the electric axle includes an e-machine.

Aspect 21 generally concerns the system of any previous aspect in which the e-machine is electrically coupled to the ESS.

Aspect 22 generally concerns the system of any previous aspect in which the electric axle includes a transmission.

Aspect 23 generally concerns the system of any previous aspect in which the e-machine is electrically coupled to the electric motor.

Aspect 24 generally concerns the system of any previous aspect in which the electric axle includes an inverter.

Aspect 25 generally concerns the system of any previous aspect in which the inverter is electrically coupled between the ESS and e-machine.

Aspect 26 generally concerns the system of any previous aspect in which the inverter is electrically coupled between the electric motor and the e-machine.

Aspect 27 generally concerns the system of any previous aspect in which the cradle supports the e-machine and the transmission.

Aspect 28 generally concerns the system of any previous aspect in which the cradle supports in the inverter.

Aspect 29 generally concerns the system of any previous aspect in which the electric axle includes a hydraulics system.

Aspect 30 generally concerns the system of any previous aspect in which the hydraulics system includes a shifter.

Aspect 31 generally concerns the system of any previous aspect in which the shifter is configured to shift gears in the transmission.

Aspect 32 generally concerns the system of any previous aspect in which the shifter is a hydraulic shifter.

Aspect 33 generally concerns the system of any previous aspect in which the transmission is a two-speed transmission.

Aspect 34 generally concerns the system of any previous aspect in which the hydraulic system includes a sump tank.

Aspect 35 generally concerns the system of any previous aspect in which the electric axle includes a sump guard positioned to protect at least the sump tank.

Aspect 36 generally concerns the system of any previous aspect in which the hydraulics system includes a differential lock pin.

Aspect 37 generally concerns the system of any previous aspect in which the hydraulics system includes a dry sump tank.

Aspect 38 generally concerns the system of any previous aspect in which the hydraulics system includes one or more scavenger pumps.

Aspect 39 generally concerns the system of any previous aspect in which the scavenger pumps are fluidly coupled between the sump tank and the dry sump tank.

Aspect 40 generally concerns the system of any previous aspect in which the hydraulics system includes an electric pump.

Aspect 41 generally concerns the system of any previous aspect in which the hydraulics system includes an accumulator.

Aspect 42 generally concerns the system of any previous aspect in which the hydraulics system includes one or more anti-vortex covers.

Aspect 43 generally concerns the system of any previous aspect in which the electric axle includes a suspension.

Aspect 44 generally concerns the system of any previous aspect in which the suspension is an independent suspension.

Aspect 45 generally concerns the system of any previous aspect in which the suspension is coupled to the cradle.

Aspect 46 generally concerns the system of any previous aspect in which the suspension includes a lower suspension arm and an upper suspension arm.

Aspect 47 generally concerns the system of any previous aspect in which the lower suspension arm and the upper suspension arm are pivotally coupled to the cradle.

Aspect 48 generally concerns the system of any previous aspect including one or more suspension bushings pivotally coupling the lower suspension arm and the upper suspension arm to the cradle.

Aspect 49 generally concerns the system of any previous aspect in which the suspension arms are coupled to the wheels of the vehicle.

Aspect 50 generally concerns the system of any previous aspect including a drive shaft connecting the transmission to the wheel.

Aspect 51 generally concerns the system of any previous aspect in which the suspension includes a damper.

Aspect 52 generally concerns the system of any previous aspect in which the damper is connected between the lower suspension arm and the cradle.

Aspect 53 generally concerns the system of any previous aspect in which the suspension includes a spring.

Aspect 54 generally concerns the system of any previous aspect in which the spring is disposed between the lower suspension arm and the cradle.

Aspect 55 generally concerns the system of any previous aspect in which the spring is disposed around the damper.

Aspect 56 generally concerns the system of any previous aspect in which the suspension includes a stabilizer system.

Aspect 57 generally concerns the system of any previous aspect in which the stabilizer system includes an anti-roll bar.

Aspect 58 generally concerns the system of any previous aspect in which the anti-roll bar is coupled to the cradle.

Aspect 59 generally concerns the system of any previous aspect in which the anti-roll bar extends across the electric axle to connect the suspensions at the opposing wheels of the electric axle.

Aspect 60 generally concerns the system of any previous aspect in which the anti-roll bar has anti-roll arms located at opposing ends of the anti-roll bar.

Aspect 61 generally concerns the system of any previous aspect in which the anti-roll arms are connected to the lower suspension arms via anti-roll drop links.

Aspect 62 generally concerns the system of any previous aspect in which the electric axle includes a steering system.

Aspect 63 generally concerns the system of any previous aspect in which the steering system includes a steering crossbar.

Aspect 64 generally concerns the system of any previous aspect in which the cross bar extends between the independent suspensions for the opposing wheels of the electric axle.

Aspect 65 generally concerns the system of any previous aspect in which the steering crossbar is coupled to the upper steering arm via a steering knuckle.

Aspect 66 generally concerns the system of any previous aspect in which the steering crossbar has a load point.

Aspect 67 generally concerns the system of any previous aspect in which the electric axle includes a brake system.

Aspect 68 generally concerns the system of any previous aspect in which the brake system includes inboard brakes.

Aspect 69 generally concerns the system of any previous aspect in which the brake system includes outboard brakes.

Aspect 70 generally concerns the system of any previous aspect including a spring friction damper disposed between the engine and the electric motor.

Aspect 71 generally concerns the system of any previous aspect including a direct current (DC) link.

Aspect 72 generally concerns the system of any previous aspect in which the DC link includes a high voltage DC bus bar.

Aspect 73 generally concerns the system of any previous aspect in which the DC link electrically couples the ESS to the electric axle.

Aspect 74 generally concerns the system of any previous aspect in which the DC link electrically couples the ESS to the inverter.

Aspect 75 generally concerns the system of any previous aspect in which the ESS is electrically coupled to the electric motor via one or more inverters.

Aspect 76 generally concerns the system of any previous aspect in which the electric axle is independent from the chassis.

Aspect 77 generally concerns the system of any previous aspect in which the electric axle is secured underneath the chassis.

Aspect 78 generally concerns the system of any previous aspect in which the chassis includes a central survival cell.

Aspect 79 generally concerns the system of any previous aspect in which the central survival cell is a steel box.

Aspect 80 generally concerns the system of any previous aspect including front and rear electric axles forming front and rear sections of the chassis.

Aspect 81 generally concerns the system of any previous aspect including an inverter for the ESS.

Aspect 82 generally concerns the system of any previous aspect in which the inverter for the generator coupled to the engine, the inverter for the electric axle, and the ESS are connected via the high voltage DC bus bar.

Aspect 83 generally concerns the system of any previous aspect including a vehicle control system.

Aspect 84 generally concerns the system of any previous aspect in which the vehicle control system is configured to closed loop control the electric axle and the engine to maintain the charge and/or discharge rate of the ESS to maintain vehicle propulsion.

Aspect 85 generally concerns the system of any previous aspect in which the hydraulic system includes a hydraulic scavenger system.

Aspect 86 generally concerns the system of any previous aspect in which the steering knuckle is configured to be driven by a conventional steering box, a solid link to the electric axle frame, an electric flyby wire steering actuator, or an electric-hydraulic flyby wire steering actuator.

Aspect 87 generally concerns the system of any previous aspect in which the hydraulics system includes a lubrication mechanical pump.

Aspect 88 generally concerns the system of any previous aspect including an active ride height and roll control system.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a block diagram of a vehicle with a powertrain system having one or more electric axles according to one example.

FIG. 2 is a perspective view of the powertrain system of the FIG. 1 vehicle.

FIG. 3 is a side view of the FIG. 1 vehicle.

FIG. 4 is an enlarged view of the electric axle used in the FIG. 1 vehicle.

FIG. 5 is an enlarged cross-sectional view of the electric axle used in the FIG. 1 vehicle.

FIG. 6 is a diagram of a hydraulics system used in the electric axle.

FIG. 7 is a cross-sectional view of the electric axle used in the FIG. 1 vehicle.

FIG. 8 is an enlarged cross-sectional view of the electric axle when mounted in the FIG. 1 vehicle.

FIG. 9 is an enlarged cross-sectional view of a scavenger pump used in the electric axle.

FIG. 10 is an enlarged cross-sectional view of the electric axle showing the accumulator and the electric pump.

FIG. 11 is an enlarged cross-sectional view of the shift actuator in the electric axle.

FIG. 12 is an enlarged cross-sectional view of the differential lock piston in the electric axle.

FIG. 13 is a perspective view of the FIG. 12 differential lock piston.

FIG. 14 is an enlarged view of the electric axle showing the anti-vortex covers and the suction pipes for the hydraulics system in the electric axle.

FIG. 15 is a cross-sectional perspective view of the scavenger pump and the anti-vortex cover.

FIG. 16 is an enlarged cross-sectional view of a pipe opening for the suction pipe at the scavenger pump.

FIG. 17 is a perspective view of the pipe openings of the suction pipes.

FIG. 18 is a perspective view of the cradle and the suspension for the electric axle mounted to the chassis of the vehicle.

FIG. 19 is a perspective view of the electric axle.

FIG. 20 is a rear view of the electric axle.

FIG. 21 is a front view of the electric axle.

FIG. 22 is a side perspective view of the electric axle.

FIG. 23 is an enlarged perspective view of the stabilizer system in the electric axle.

FIG. 24 is a side perspective view of the suspension for the electric axle.

FIG. 25 is an enlarged perspective view of the steering linkage of the electric axle.

FIG. 26 is a cross-sectional view of a steering knuckle used in the electric axle.

FIG. 27 is an enlarged cross-sectional view of the steering knuckle.

FIG. 28 is a diagram of the steering knuckle.

FIG. 29 is a perspective view of the brake system used for the electric axle.

FIG. 30 is an enlarged perspective view of the brake system.

FIG. 31 is an enlarged perspective view of the brake caliper for the brake system.

FIG. 32 is a perspective view of a bushing used in the electric axle.

FIG. 33 is a cross-sectional view of the bushing.

FIG. 34 is an enlarged cross-sectional view of the bushing.

FIG. 35 is a cross-sectional view of a wheel assembly for the vehicle.

FIG. 36 is a cross-sectional view of the electric axle.

FIG. 37 is a cross-sectional view of the electric axle.

FIG. 38 is a cross-sectional view of an electric axle according to another example.

FIG. 39 is a perspective view of a system with an electric axle according to a further example.

FIG. 40 is a cross-sectional perspective view of the FIG. 39 electric axle.

FIG. 41 is a cross-sectional view of the FIG. 39 electric axle.

FIG. 42 is a cross-sectional view of the FIG. 39 electric axle.

FIG. 43 is a perspective view of an electric axle according to still yet another example.

FIG. 44 is a perspective view of the FIG. 43 electric axle.

FIG. 45 is a top view of the FIG. 43 electric axle.

FIG. 46 is a rear view of the FIG. 43 electric axle.

FIG. 47 is a first side view of the FIG. 43 electric axle.

FIG. 48 is a second side view of the FIG. 43 electric axle.

FIG. 49 is a cross-sectional view of the FIG. 43 electric axle.

FIG. 50 is an enlarged cross-sectional view of the FIG. 43 electric axle.

FIG. 51 is a cross-sectional view of an upright assembly for the wheel in the vehicle.

FIG. 52 is a diagram of a power system according to another example.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

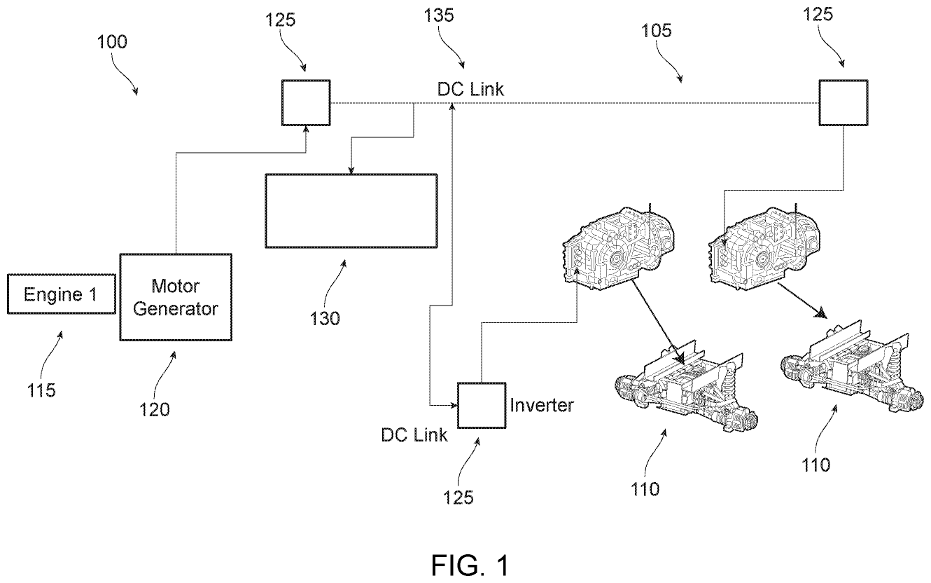

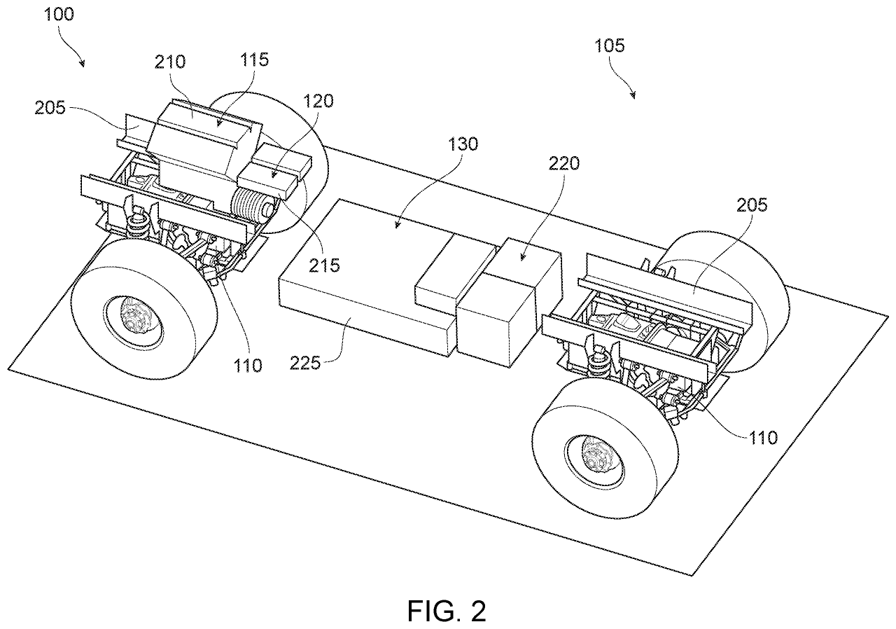

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

Referring to FIG. 1, a vehicle 100 with a unique powertrain system 105 has been developed to address the above-mentioned as well as other issues. The powertrain system 105 includes a unique electric axle 110 or e-axle that is configured to move the vehicle 100. In the depicted example, the powertrain system 105 has two electric axles 110, but the powertrain system 105 in other examples can include more or less electric axles 110 than are shown in FIG. 1. Along with the powertrain system 105, the vehicle 100 further includes an engine 115 and a motor generator or e-machine 120 mechanically coupled to the engine 115 for generating electrical energy for powering the electric axles 110. To convert alternating current (AC) from the electric axles 110 and the engine 115 to direct current (DC), the vehicle 100 has one or more inverters 125. As shown, the inverters 125 are electrically coupled to the e-machine 120 or the electric axles 110. The inverters 125 convert the alternating current from the electric axles 110 and the engine 115 to direct current so as to facilitate storage of the electrical energy in an energy storage system (ESS) 130. In the depicted example, the ESS 130 is electrically coupled to the inverter 125 via a direct current link (DC link) 135. The electrical energy stored in the ESS 130 can be used to power the electric axles 110 so as to move the vehicle 100. Each electric axle 110 has an independent suspension 1810 that allows the vehicle 100 to efficiently move across even the toughest terrains. In some cases, the electric axle 110 is able to propel the vehicle 100 at seventy miles-per-hour (70) or greater, and the electric axle 110 is able to move the vehicle 100 up a sixty percent (60%) grade or greater. The electric axle 110 is further able to operate even under the harshest conditions. For example, when used in military vehicles 100, the electric axle 110 further includes shielding that is configured to direct the force of an explosion, such as from an improvised explosive device (IED), away from one or more key components of the electric axle 110 such that the electric axle 110 is able to operate even after the explosion.

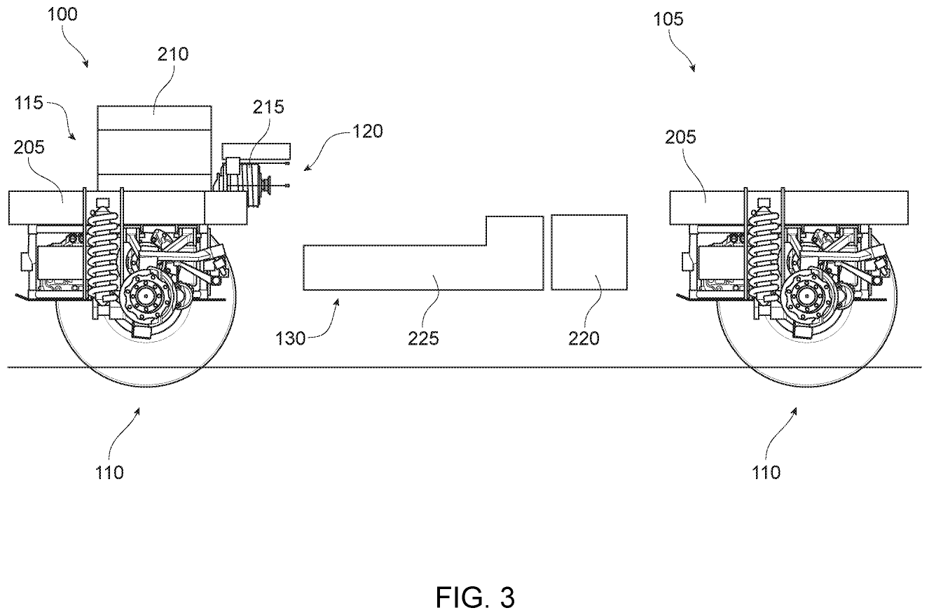

Turning to FIGS. 2 and 3, the electric axle 110 is constructed to be modular in nature so that the electric axle 110 can be readily adapted for use in a wide variety of vehicle configurations. For instance, all or some components of the electric axle 110 can be adapted for use in series hybrid vehicles, parallel hybrid vehicles, series-parallel hybrid vehicles, or battery electric vehicles (BEVs), to name just a few examples. In one version, one or more electric axles 110 are installed at the axle locations of a series hybrid type vehicle. The vehicle 100 includes a chassis 205. The engine 115 in the illustrated example includes an internal combustion engine 210 mounted to the chassis 205, and the e-machine 120 includes an electric generator 215 connected to the internal combustion engine 210. The vehicle 100 has a fuel tank 220 mounted to the chassis 205 that supplies fuel, like diesel fuel or gasoline, to power the internal combustion engine 210. The ESS 130 in the depicted vehicle 100 includes a battery 225, such as in the form of a battery pack, that is configured to store energy. The vehicle 100 includes one or more of the electric axles 110 that are mounted to the chassis 205. The electric axles 110 can be placed in the vehicle 100 in a forward orientation, as is shown, or in a backwards orientation, depending on the step climb requirements.

The modular nature of the electric axle 110 allows the electric axle 110 to be installed at a single axle of the vehicle 100 or on multiple axles of the vehicle 100. In other words, the electric axle 110 is able to scale with the size of the vehicle 100. For instance, the electric axle 110 in one version is installed on a single axle of a light duty vehicle 100. In a further version, the vehicle 100 has two (2) electric axles 110. In still yet other versions, each of the five (5) axles of a common tractor-trailer design includes the electric axle 110. In some cases, the same vehicle 100 can incorporate eight (8) or more electric axles 110. It should be recognized that the number of electric axles 110 on a vehicle 100 can vary depending on a number of factors such as the size and power requirements of the vehicle 100. Having the electric axle 110 powering multiple axles can be helpful in defense environments, because it can enhance overall survivability of the vehicle 100. For instance, when one or more of the subsystems of the vehicle 100 fail, the other parts of the system can compensate so that the vehicle 100 is able to maintain mobility. In other words, the vehicle 100 can limp home even if one of the electric axles 110 is inoperative. Through regenerative braking and other capabilities provided by the electric axle 110, the range of the vehicle 100 can be extended as compared to conventional internal combustion engine configurations. When operating under constant stop-start conditions or locations, the system is able to optimize fuel consumption by allowing the internal combustion engine 210 to always operate in a more efficient operational range as long as the battery 225 has enough charge rate capacity after delivering the traction power. While driving at low speeds in city conditions, a controller system for the vehicle 100 is configured to operate the internal combustion engine 210 nearer to the optimum brake specific fuel consumption (BSFC) point for the vehicle 100. The controller is able to operate the internal combustion engine 210 near the optimum BSFC point under other conditions such as on steep grades and/or at speeds below four (4) miles per hour (mph).

In one particular version, the vehicle 100 is a series hybrid with twin independent electric axles 110. It was found that this configuration had a higher redundancy capabilities as compared to conventional powertrains. In other words, even if some failures in the vehicle powertrain system 105 occurred, the vehicle 100 was still able to operate. For instance, if one of the electric axles 110 fails, the other electric axle 110 is able to compensate for the loss such that vehicle 100 is still able to operate. In another example, if the battery 225 fails, the internal combustion engine 210 and the generators 215 are still able to provide power, and if the internal combustion engine 210 fails, the battery 225 is able to provide electrical power to one or more electric axles 110 so that the vehicle 100 is still mobile. The twin independent axles further increase the range of the vehicle 100 for the same fuel load. While still meeting the most challenging operational requirements, the design further is able to incorporate preexisting hardware. As alluded to before, the system is still able to optimize BSFC even for preexisting hybrid vehicle designs.

The modular electric axle 110 can function as purely a drive axle that transmits power to the wheels or as a steering axle that is able to turn the wheels in order to steer the vehicle 100. In other words, each electric axle 110 is capable of providing drive power to the wheels and/or steer the wheels of the vehicle 100. In one case, the electric axle 110 located at the rear of the vehicle 100 is steered to reduce the turning radius of the vehicle 100. Even when acting as a steering axle, the electric axle 110 can provide power to the wheels, and in other cases, the electric axle 110 may not provide power to the wheels when acting as a steering axle. For instance, the electric axle 110 in some cases can be used solely for regenerative braking purposes to recharge the battery 225 on the vehicle 100 (or not). In one version, the electric axle 110 has the ability to select neutral for at least two conditions. One of these conditions occurs for example when the driving surface has high traction, and in such a high traction condition, it is more efficient to only have the losses on one electric axle 110. By having at least one of the electric axles 110 in neutral removes the inertia of the electric machine of the electric axle 110 in neutral from the driveline. The second condition can occur during braking with an anti-lock braking system (ABS). During an ABS braking event, the motor is separated from the driveline to allow the ABS to have full control of the wheel. The modular nature of the electric axle 110 further allows electric axles 110 to be easily swapped out or replaced with others. This modular nature of the electric axle 110 can be helpful in combat or other military defense situations when damage occurs. In other words, the modular system facilitates fast turnaround repairs. For example, the damaged electric axle 110 can be entirely replaced or fixed with parts scavenged from other electric axles 110. When the electric axle 110 includes internal brakes, the internal brakes in some versions includes separate brake calipers to act as parking brakes.

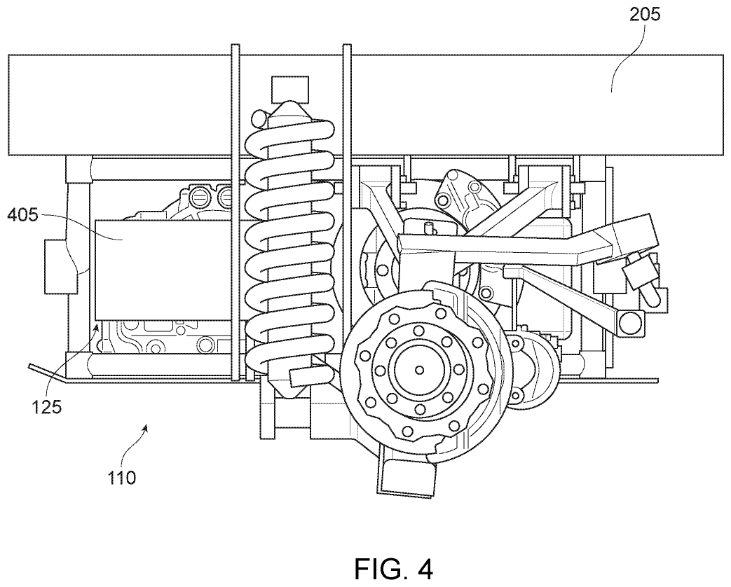

In one version depicted in FIG. 4, each electric axle 110 includes an inverter 125 that is electrically connected to the ESS 130 and/or the generator 215 connected to the internal combustion engine 210. In at least some variations, each electric axle 110 includes at least one of the inverters 125. As shown in FIG. 4, the inverter 125 includes an axle inverter 405 that is mounted in the electric axle 110. Having the inverter 405 incorporated into the electric axle 110 further enhances the modular nature of the electric axle 110. In one variation, each electric axle 110 has a dedicated inverter 125 to control wheel speed independently. In other words, one inverter 125 is used per drive motor-generator. In other variations, the inverter 125 may be shared between the electric axles 110. In other iterations, two inverters 125 are located within a single housing, and in this case, there are two inverters 125 for the three-phase motor-generators. In one particular example, a six-phase inverter 125 provides power to two separate three-phase motor-generators. In some variations, the electric axle 110 further includes a projectile protection plate 525 positioned to protect the inverter 125 as well as other components of the electric axle 110. In some cases, the electric axle 110 further has a flat shield or a V-shaped shield positioned between the electric axle 110 and the driving surface to protect the electric axle 110 from explosions or debris. The electric axle 110 further includes an electric motor-generator or e-machine 120 that is electrically coupled to the inverter 125 and a transmission that is mechanically coupled to the e-machine 120. In one version, the transmission is a two-speed transmission that includes one or more planetary gears and clutches arranged along a parallel axis. The transmission in one form has a hydraulic shift actuator or an electrical shift actuator configured to shift the gears of the transmission.

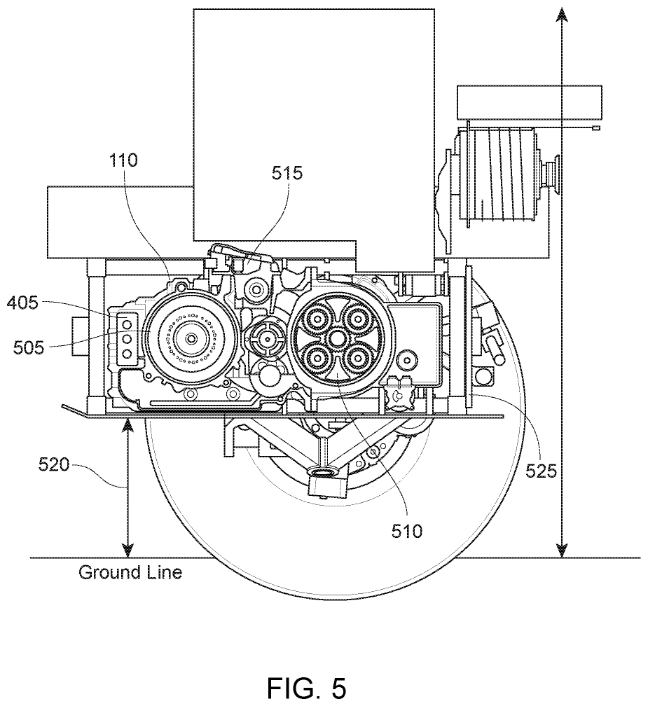

Looking at FIG. 5, the electric axle 110 further includes an electric motor-generator or e-machine 505 that is electrically coupled to the inverter 405 and a transmission 510 that is mechanically coupled to the e-machine 505. In one version, the transmission 510 is a two-speed transmission 510 that includes one or more planetary gears and clutches. The transmission 510 in one form has a shift actuator 515 configured to shift the gears of the transmission 510. By shifting the gears in the transmission 510, the shift actuator 515 is able to change the speed and/or torque from the e-machine 505 that is delivered to the wheels of the vehicle 100. The electric axle 110 is designed to provide a high ground clearance height 520 so as to be able to clear most ground obstacles, such as rocks and debris. At one end, the electric axle 110 further has a projectile protection plate 525 that protects the components inside the electric axle 110 from projectiles or other sources of damage.

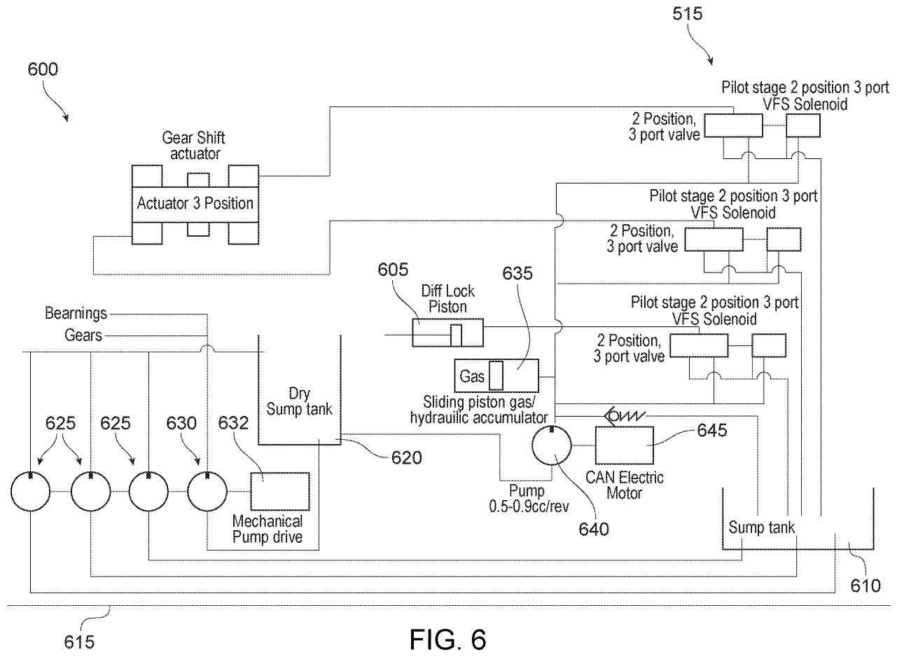

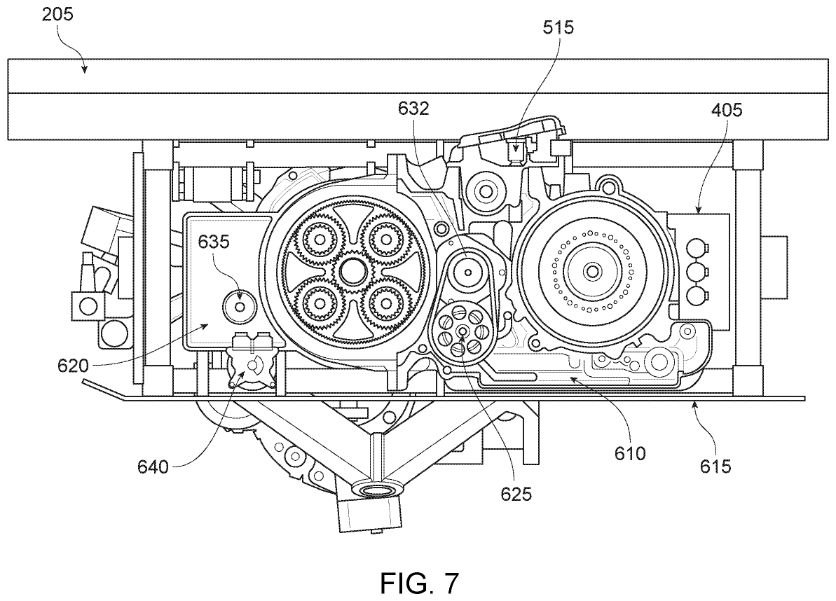

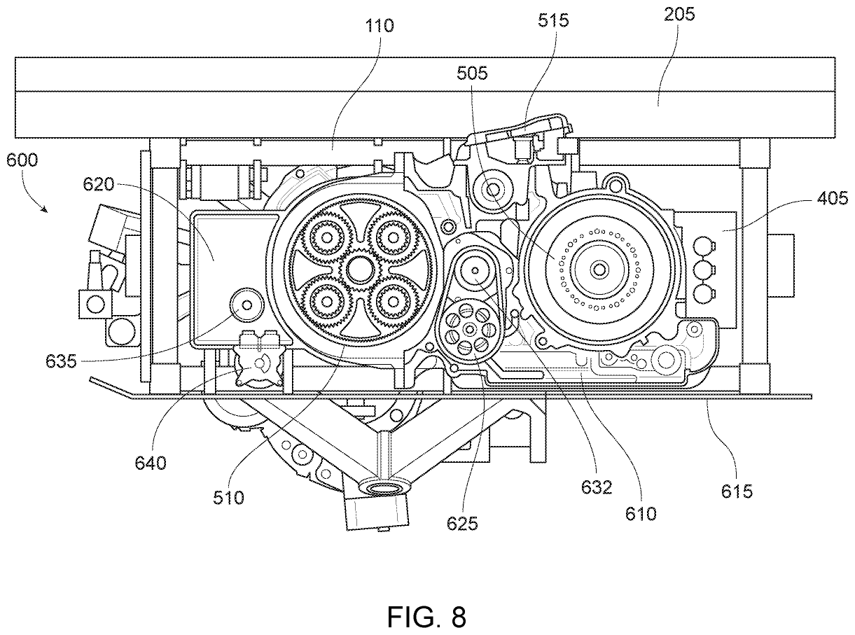

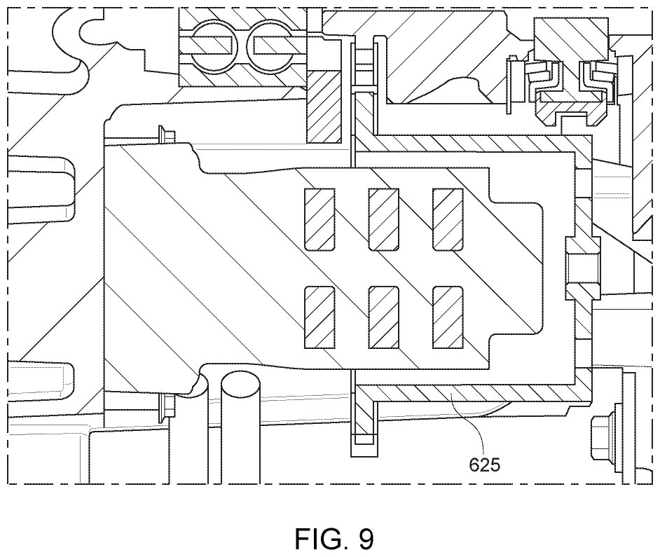

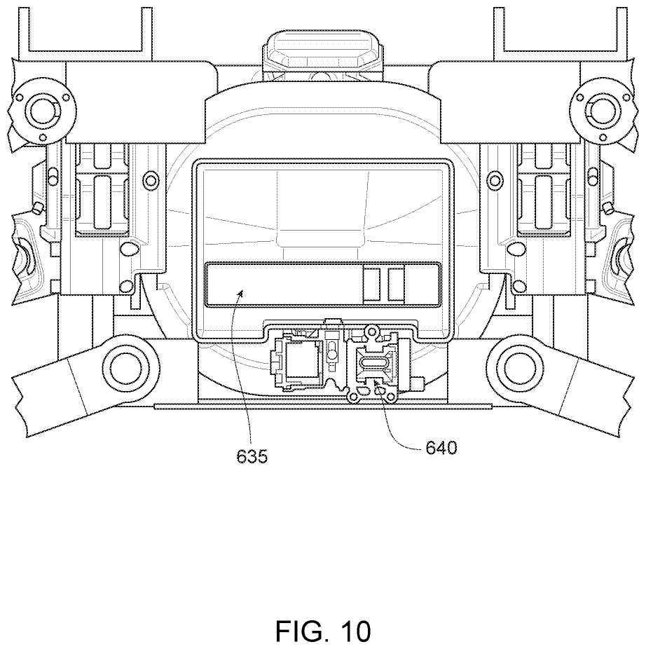

Referring to FIGS. 6, 7, 8, 9, and 10, the electric axle 110 further includes a hydraulics system 600 that is designed to operate even under extreme conditions. For instance, the hydraulics system 600 in some cases is able to operate when the vehicle 100 is at a 60% grade or even a higher grade. The hydraulics system 600 is configured to circulate a hydraulic fluid, such as a lubricant, throughout the electric axle 110. Among other things, the circulated hydraulic fluid is used to lubricate and cool components within the electric axle 110 such as the e-machine 505 and the transmission 510. In one version, the vehicle 100 has cooler ports which bring cooling water to the electric axle 110. The water is used to directly cool the e-machine 505 in the electric axle 110. By keeping the e-machine 505 cool with water, the remaining parts of the system can have an oil-water heat exchanger to further cool the transmission 510. The hydraulics system 600 includes the hydraulic shift actuator 515 that is configured to shift the gears in the transmission 510. In one example, the hydraulics system 600 has a differential lock piston 605 that was shortened in order to fit within the tight constraints of the electric axle 110. Alternatively or additionally, the electric axle 110 includes an internal hydraulic brake.

The hydraulics system 600 further includes a sump tank 610 that collects the fluid such as oil or other lubricants. A sump guard 615 is positioned proximal to the sump tank 610 to protect the sump tank 610 from being punctured such as by debris or from explosions. To facilitate operation of the vehicle 100 at high grades, the hydraulics system 600 includes a dry sump tank 620 that facilitates low pressure circulation of the hydraulic fluid. The hydraulics system 600 further includes one or more scavenger pumps 625 that circulate the hydraulic fluid from the sump tank 610 to the dry sump tank 620. To lubricate and cool various components, such as bearings and gears in the transmission 510, the hydraulics system 600 of the electric axle 110 includes a lubrication pump 630 that is fluidly coupled to the dry sump tank 620. In one version, the lubrication pump 630 is in the form of a mechanical pump that is fluidly coupled to the dry sump tank 620. The scavenger pumps 625 and the lubrication pump 630 are mechanically driven by a mechanical drive 632. In some cases, the scavenger pumps 625 and the lubrication pump 630 are mechanically coupled to the mechanical drive 632 via a belt, but it should be recognized the scavenger pumps 625 and the lubrication pump 630 can be mechanically coupled to the mechanical drive 632 in other manners, such as via a chain, gearing, and/or a drive shaft. The mechanical drive 632 can be driven in several manners, such as via the e-machine 505 and/or the transmission 510.

In some variations, the hydraulics system 600 of the electric axle 110 includes a hydraulic accumulator 635. In some variations, the hydraulics system 600 of the electric axle 110 includes an accumulator 635 and one or more anti-vortex covers. In one form, the hydraulic accumulator 635 is a piston style accumulator 635. To further facilitate fluid circulation, the hydraulics system 600 has an electric pump 640 that is fluidly coupled to the dry sump tank 620. The electric pump 640 is driven by an electric pump motor 645. By not requiring mechanical movement of the transmission 510, the electric pump 640 is able to independently provide fluid pressure and fluid circulation control.

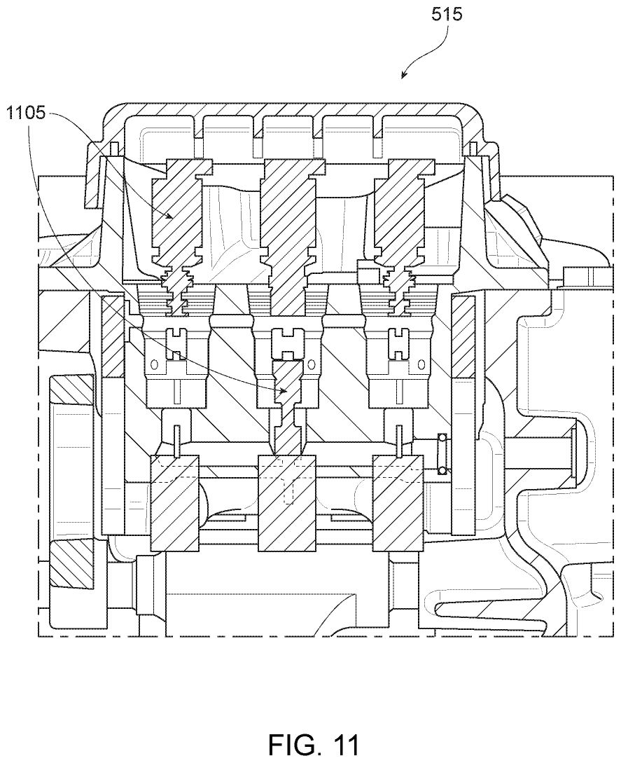

FIG. 11 shows a cross-sectional view of the shift actuator 515 in the hydraulics system 600. Once more, the shift actuator 515 is used to shift gears in the transmission 510. The shift actuator 515 includes one or more hydraulic valves 1105 for shifting the gears in the transmission 510.

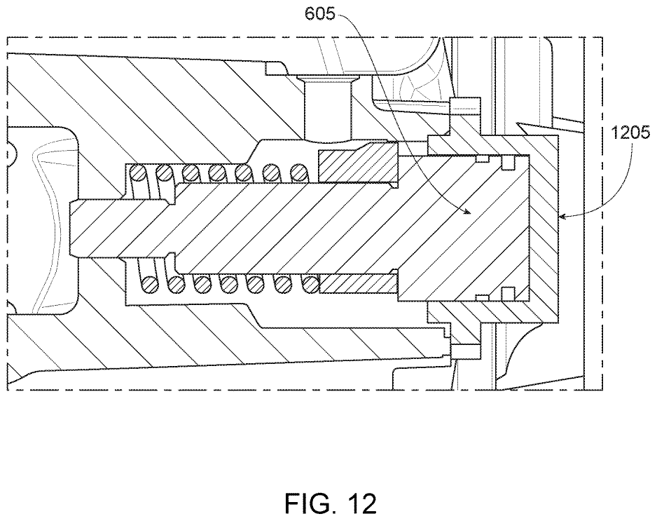

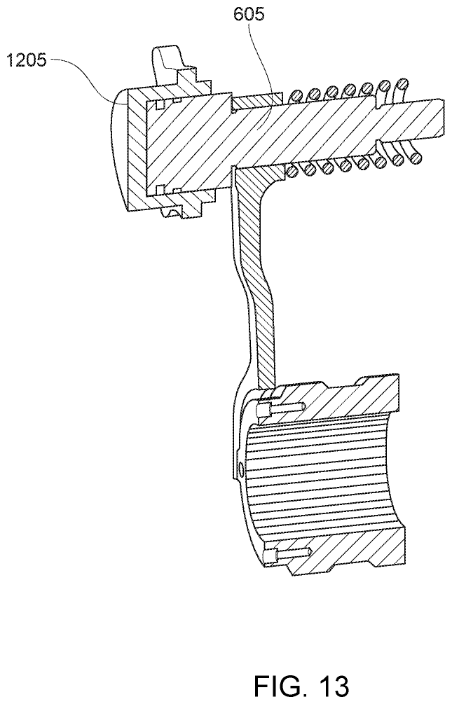

The electric axle 110 has been designed to fit within the tight confines of the vehicle 100. Selected parts of the electric axle 110 have been oriented and shaped to fit within these tight spaces. For example, one such part includes the differential lock piston 605. FIG. 12 shows a cross-sectional view of the differential lock piston 605, and FIG. 13 shows a perspective view of the differential lock piston 605. In the depicted example, the differential lock piston 605 has a piston cover 1205 that has been sized and shaped to clear the brake rotor within the electric axle 110.

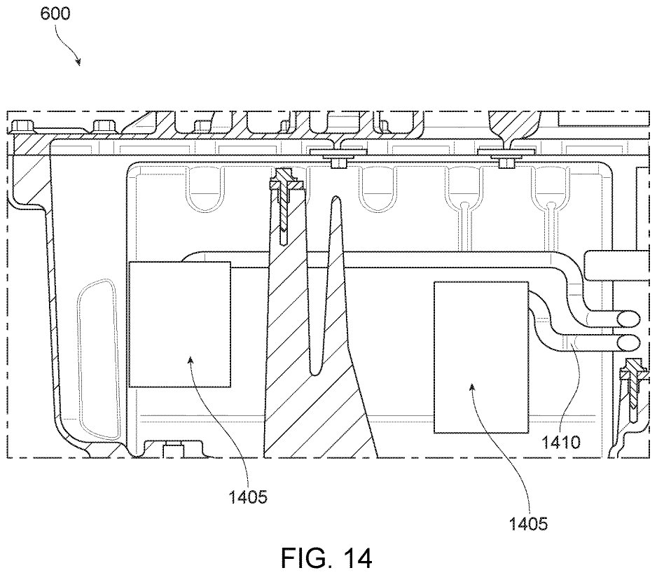

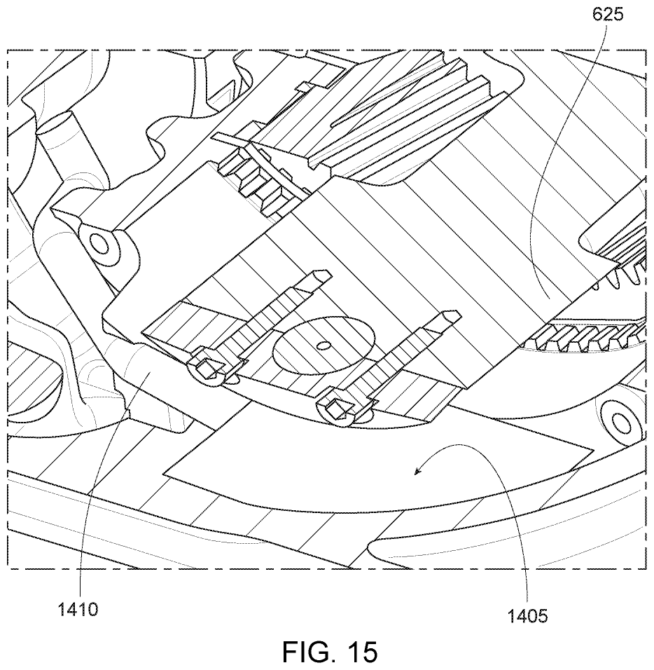

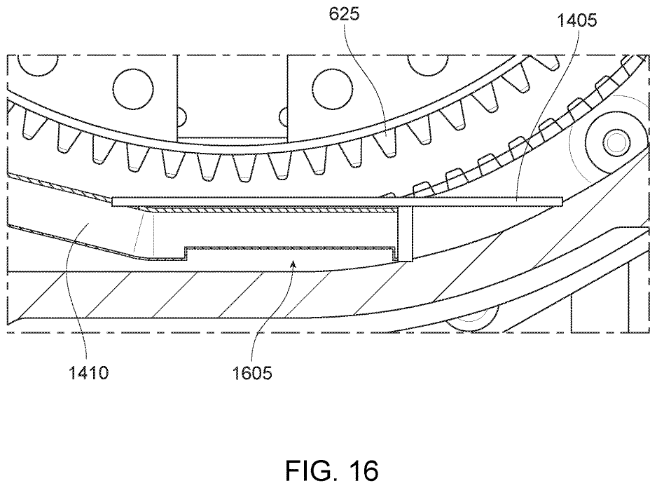

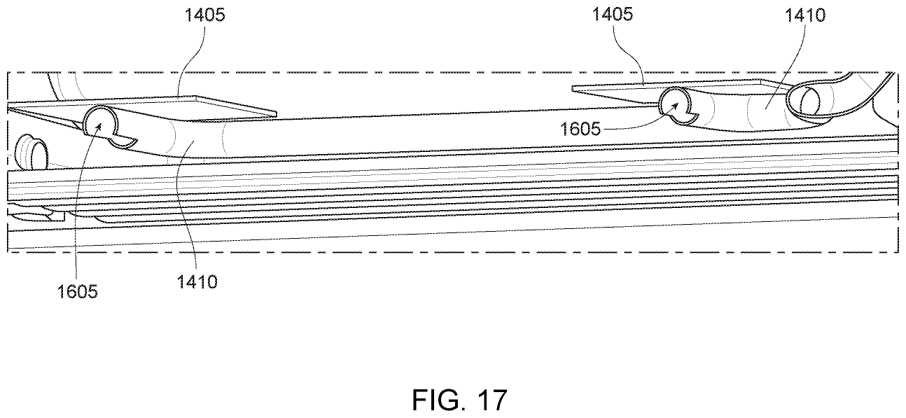

Turning to FIGS. 14 and 15, the hydraulics system 600 of the electric axle 110 proximal to the scavenger pumps 625 includes one or more anti-vortex covers 1405 that reduce formation of vortices in the fluid around the scavenger pumps 625. The hydraulics system 600 further includes one or more suction pipes 1410 that draw the fluid from the sump tank 610 to the scavenger pumps 625. Looking at FIGS. 16 and 17, the suction pipes 1410 have pipe openings 1605 that are notched-shaped to further reduce vortex formation.

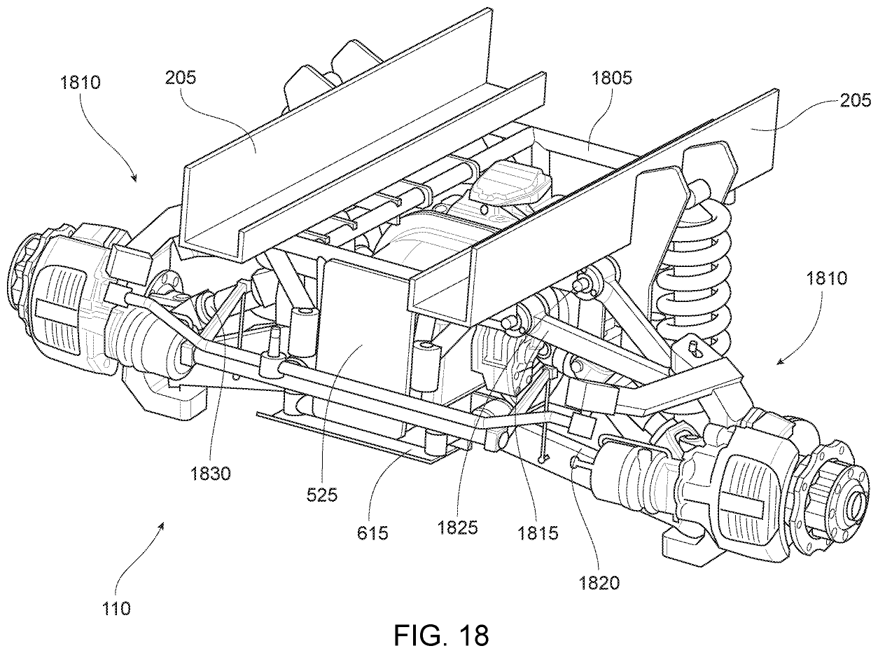

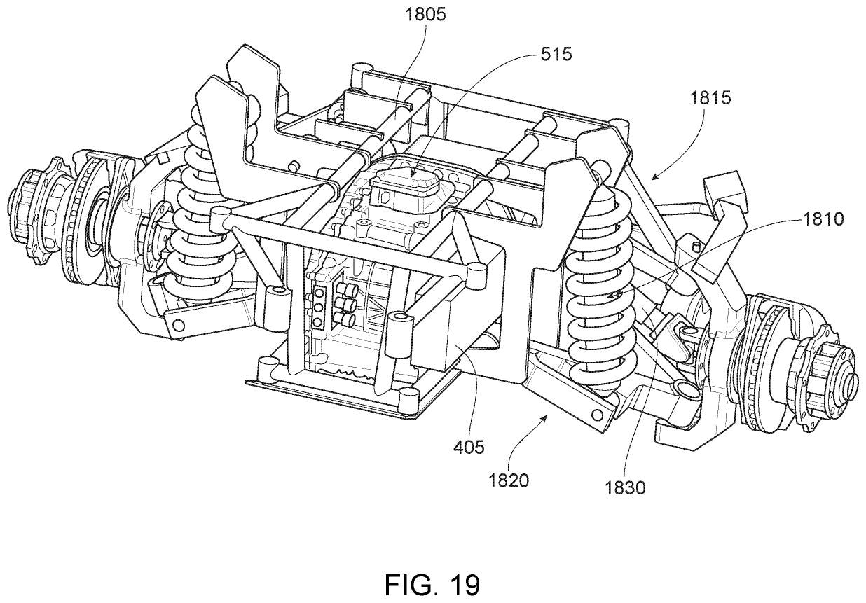

Looking at FIGS. 18 and 19, the electric axle 110 includes a unique cradle 1805 that mounts the inverter 405, the e-machine 505, and the transmission 510 to the chassis 205 of the vehicle 100. The cradle 1805 is secured to the underside of the chassis 205. The electric axle 110 further includes a unique independent suspension 1810 that couples the wheels to the cradle 1805 of the electric axle 110. The independent suspension 1810 is designed to provide sufficient clearance so that the vehicle 100 is able to clear even the most challenging obstacles. In one example, the suspension 1810 includes an upper suspension arm 1815 and a lower suspension arm 1820 that extend between the carriage and the wheel. The upper suspension arm 1815 and the lower suspension arm 1820 are each pivotally coupled to the cradle 1805 via one or more sealed bushings 1825. In one example, the upper suspension arm 1815 and the lower suspension arm 1820 are in the form of wishbone arms, but the suspension arms can be shaped differently in other variations. Between the upper suspension arm 1815 and the lower suspension arm 1820, a drive shaft 1830 of the electrical axle extends to mechanically connect the wheel to the transmission 510. Via the drive shaft 1830, the transmission 510 is able to rotate the wheel.

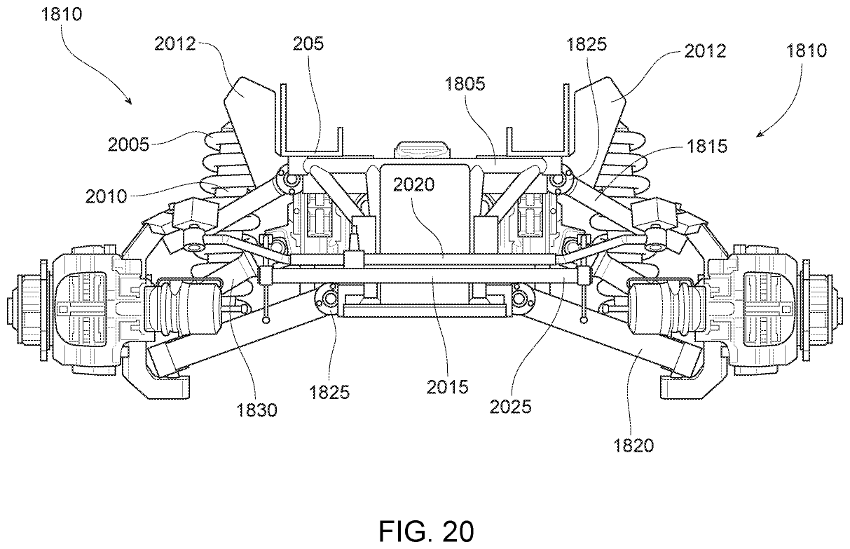

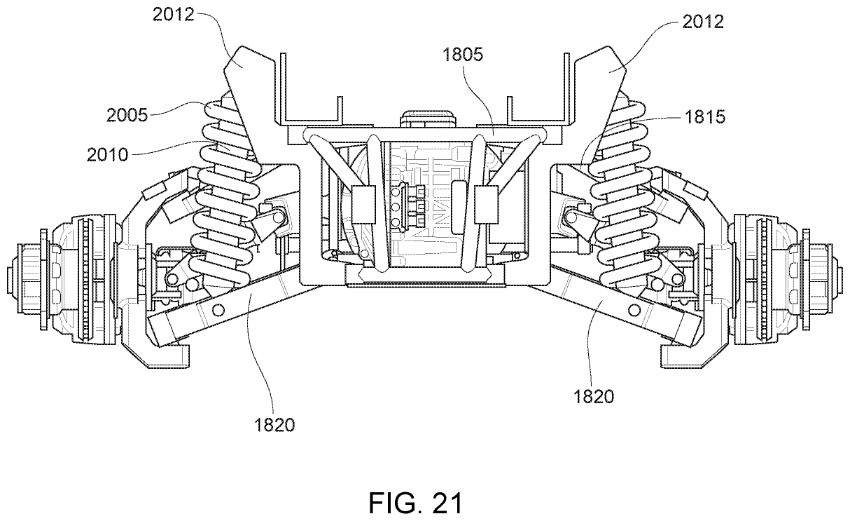

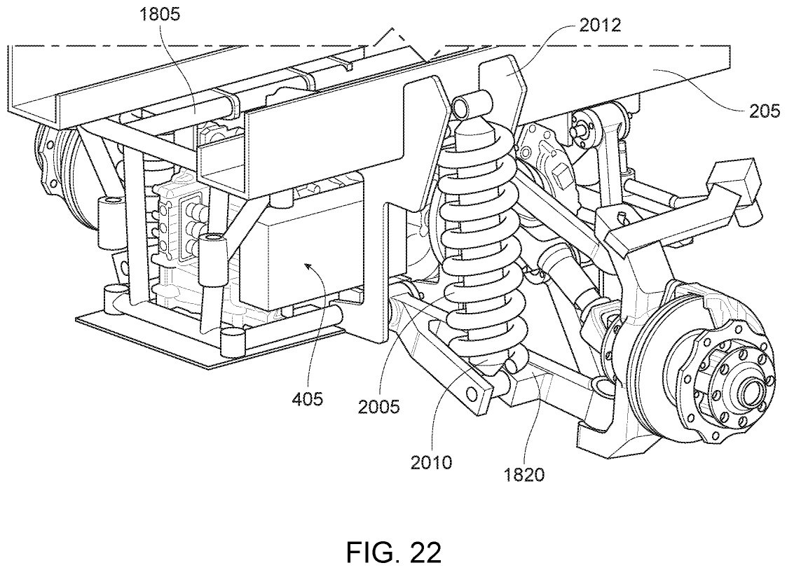

Turning to FIGS. 20, 21, and 22, the suspension 1810 further includes a spring 2005 and a damper 2010 or shock absorber. In one example, the damper 2010 and the spring 2005 are connected to and extend between the lower suspension arm 1820 and one or more mounting flanges 2012 on the cradle 1805. In one form, the spring 2005 is a helical coil spring that is wrapped around the damper 2010 to form a single unit or assembly. In other examples, the spring 2005 and the damper 2010 are separate components located at separate positions within the suspension 1810. The spring 2005 can be configured differently in other variations. For instance, the spring 2005 in other variations is in the form of a torsion bar, and in still yet another variation, the spring 2005 is an air spring 2005. The damper 2010 in one example is a hydraulic damper 2010, but the damper 2010 can include other types of dampers 2010. In one version, the electric axle 110 is designed to provide active control of the vehicle ride height and/or control/prevent vehicle roll though fluid control within the axle system. In some versions, the electric axle 110 includes an active electric hydraulic active ride height control system to vary ground clearance of the vehicle 100.

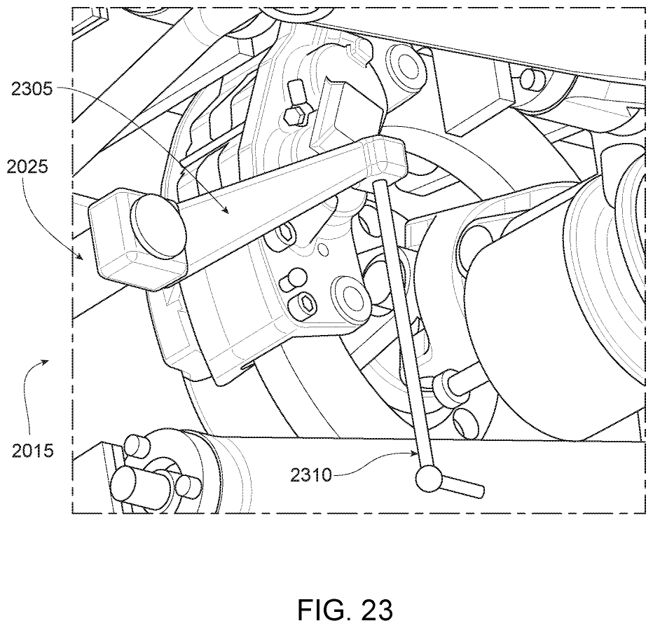

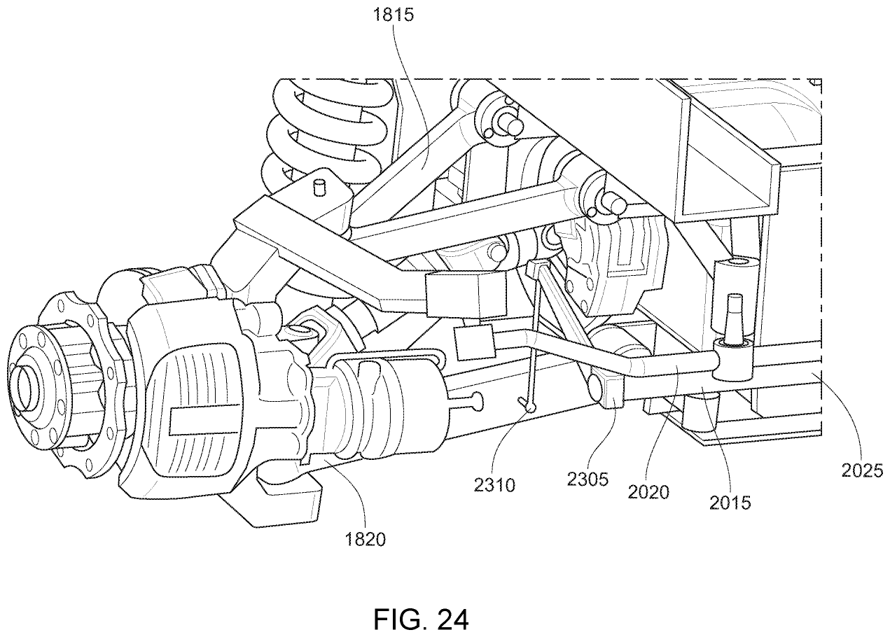

In most cases, the suspension 1810 further includes a stabilizer system 2015 and a steering system 2020. The stabilizer system 2015 is configured to reduce body roll of the vehicle 100 during cornering as well as enhance overall handling and stability of the vehicle 100. In one example, the stabilizer system 2015 includes a sway bar or anti-roll bar 2025. The anti-roll bar 2025 is coupled to the cradle 1805, and the anti-roll bar 2025 extends across the electric axle 110 to connect the suspensions 1810 at the opposing wheels of the electric axle 110. Referring to FIGS. 23 and 24, the anti-roll bar 2025 in one version has anti-roll arms 2305 located at opposing ends of the anti-roll bar 2025. The anti-roll arms 2305 in one version are connected to the lower suspension 1810 arms via one or more anti-roll drop links 2310.

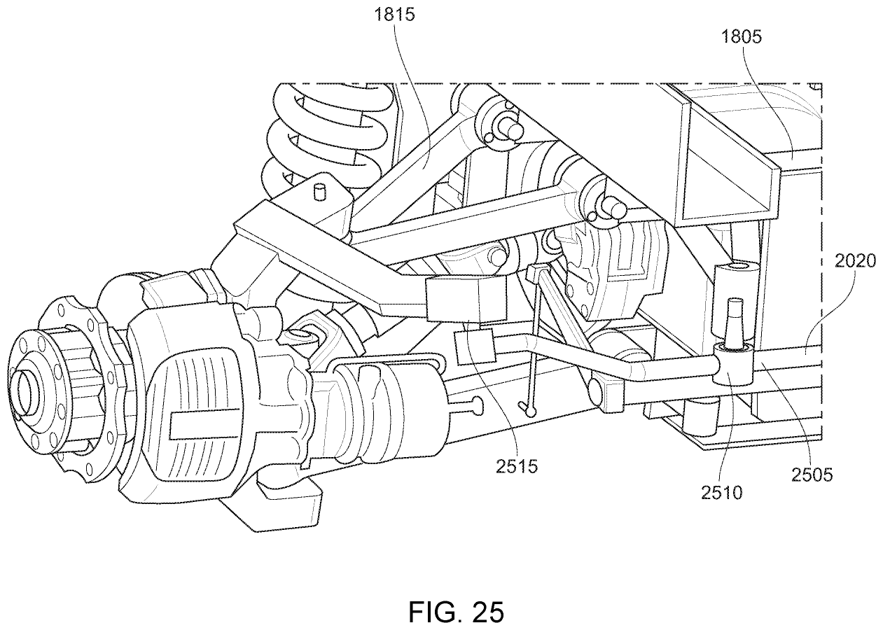

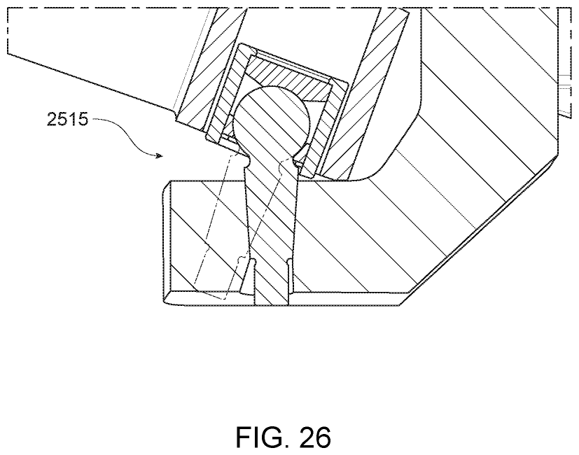

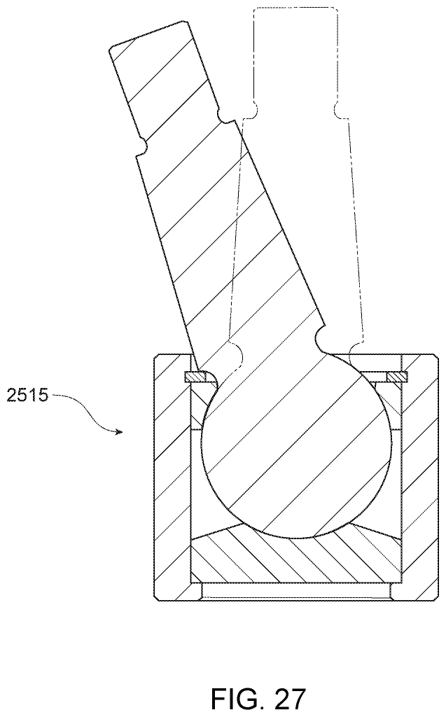

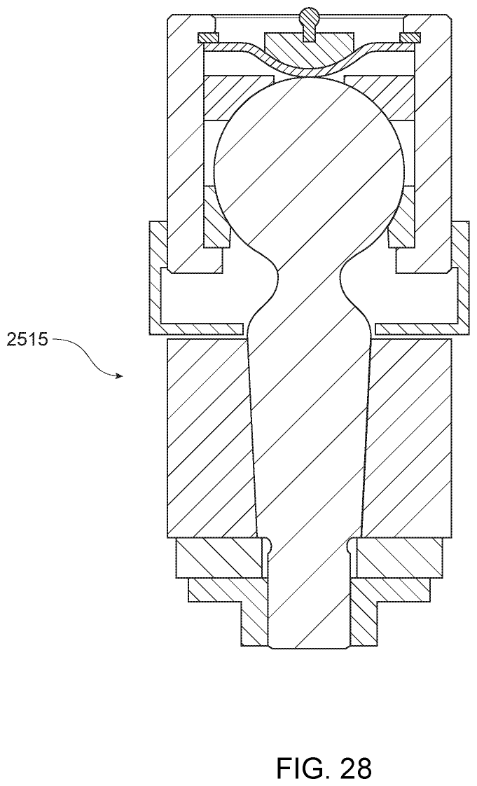

As noted before, the electric axle 110 in some variations includes the steering system 2020 to facilitate steering. In some use cases, while present, the steering system 2020 is inactive such as when the electric axle 110 is being used solely as a drive axle. In other cases, the steering system 2020 is used as a steer assist rear axle where one or more electric axles 110 located at the rear of the vehicle 100 are steered to reduce or otherwise enhance the vehicle 100 turn radius. As depicted in FIG. 25, the steering system 2020 includes a steering crossbar 2505 with a load point 2510. The steering crossbar 2505 between the independent suspensions 1810 for the opposing uprights of the electric axle 110. The steering crossbar 2505 is coupled to the upper suspension arm 1815 via a steering knuckle 2515. FIGS. 26, 27, and 28 show various cross-sectional views of the steering knuckle 2515. To steer, the load point 2510 of the steering system 2020 can be driven by a conventional steering box, a solid link to the axle frame, an electric flyby wire steering actuator, or an electric-hydraulic flyby wire steering actuator. In some cases, the vehicle 100 uses active steering control.

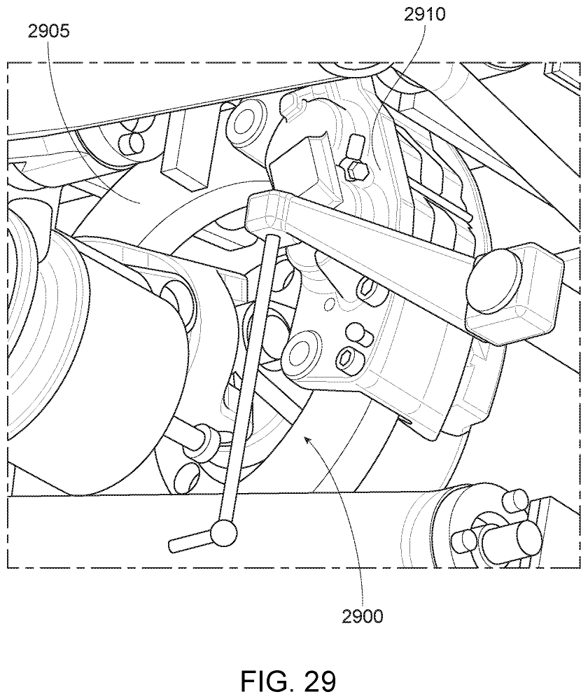

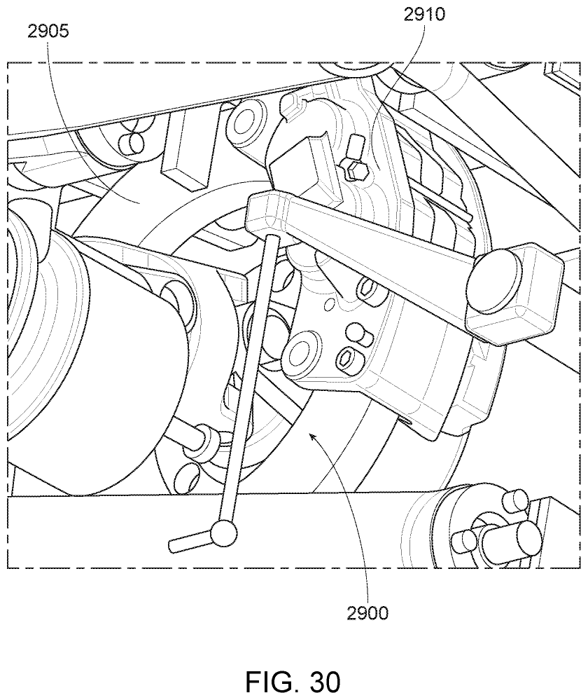

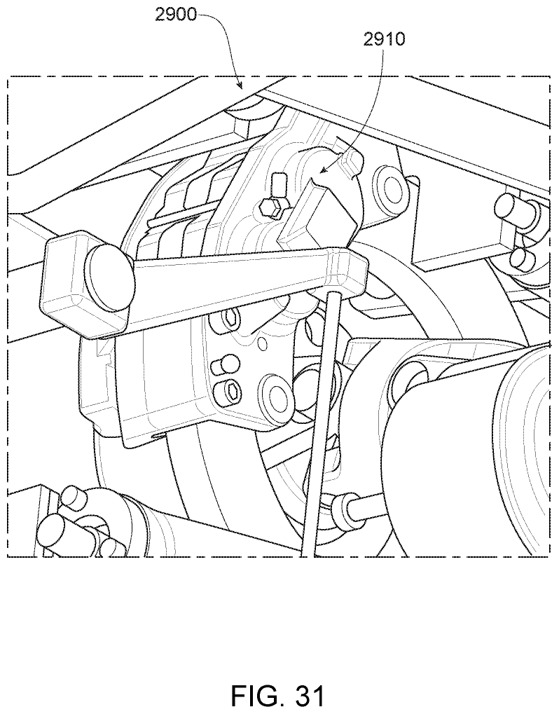

Referring to FIGS. 29, 30, and 31, the electric axle 110 is able to readily accommodate different types or styles of brake systems 2900 so as to provide different performance capabilities depending on the needs of particular use cases. For example, the electric axle 110 in one variation has an outboard located brakes where brake rotor 2905 and brake caliper 2910 are located proximal to the wheels. In other words, the brakes in the outboard configuration are located away from the transmission 510 and cradle 1805. The outboard located brakes are relatively easy to service. In another variation, the electric axle 110 has inboard brakes that are positioned in or proximal to the cradle 1805 and the transmission 510. The inboard brakes have a lower un-sprung mass that can enhance performance of the vehicle 100 such as by improving wheel traction and tire load transmissibility.

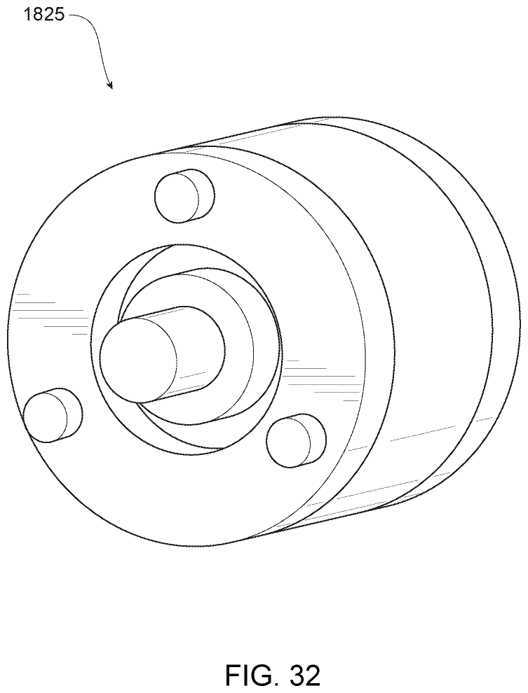

FIG. 32 shows a perspective view of the sealed suspension bushing 1825 according to one example. Referring back to FIGS. 18 and 20, the bushings 1825 are used to pivotally couple the upper suspension arms 1815 and the lower suspension arms 1820 to the cradle 1805. The bushings 1825 allow the upper suspension arms 1815 and the lower suspension arms 1820 to pivot about the cradle 1805.

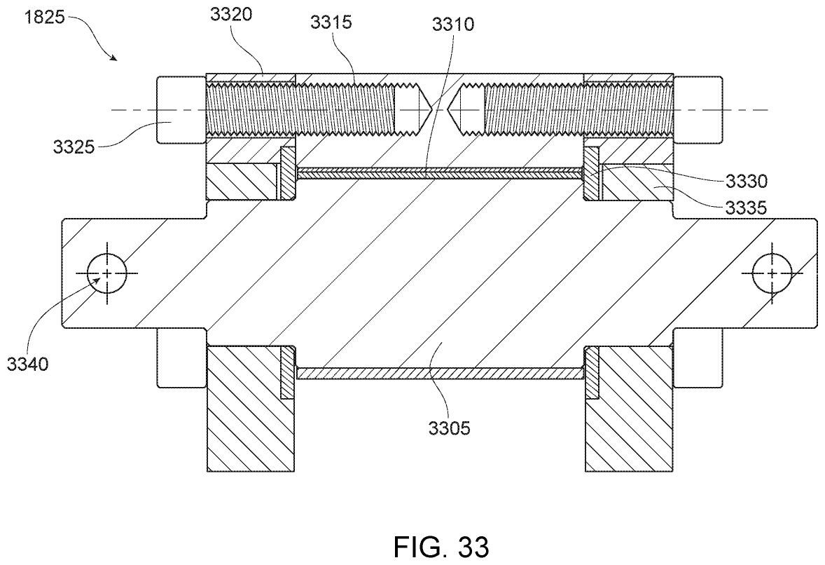

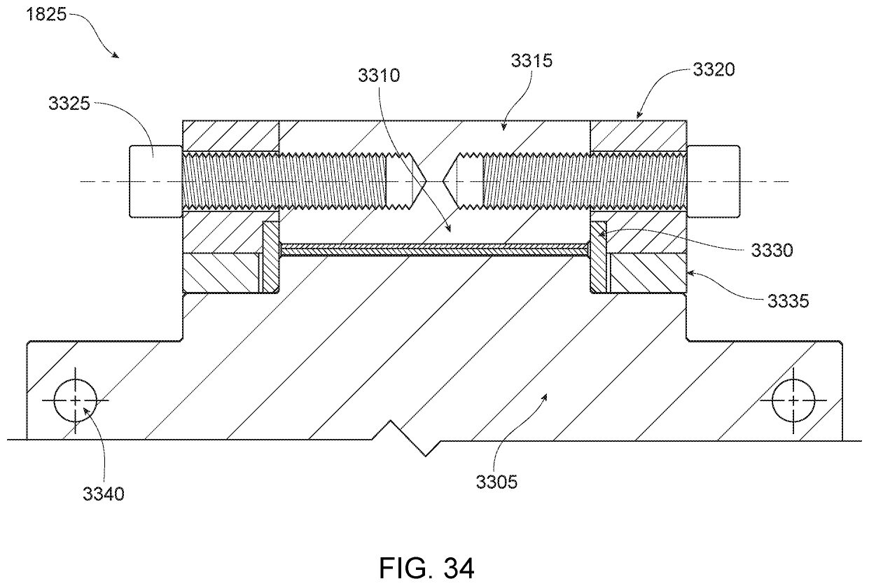

Looking at FIGS. 33 and 34, the bushings 1825 each include a spindle 3305, a plain bearing 3310, and a suspension arm 3315 that are arranged in a generally concentric manner. The suspension arm 3315 for example can include the upper suspension arm 1815 or the lower suspension arm 1820. The plain bearing 3310 allows the spindle 3305 to rotate relative to the suspension arm 3315. The suspension arm 3315 is sandwiched between opposing side plates 3320 that are secured to the suspension arm 3315 via one or more fasteners 3325, such as bolts. At opposing ends of the spindle 3305, the bushing 1825 has one or more washers 3330 and one or more cartridge seals 3335. The washers 3330 are generally disposed between the spindle 3305 and the cartridge seals 3335, and the washers 3330 are further disposed between the suspension arms 3315 and the side plates 3320. The cartridge seals 3335 are disposed between the spindle 3305 and the side plates 3320 at opposing ends of the bushing 1825. The opposing ends of the spindle 3305 have one or more fastener openings 3340 that are configured to receive fasteners for securing the bushing 1825 to the cradle 1805 of the electric axle 110.

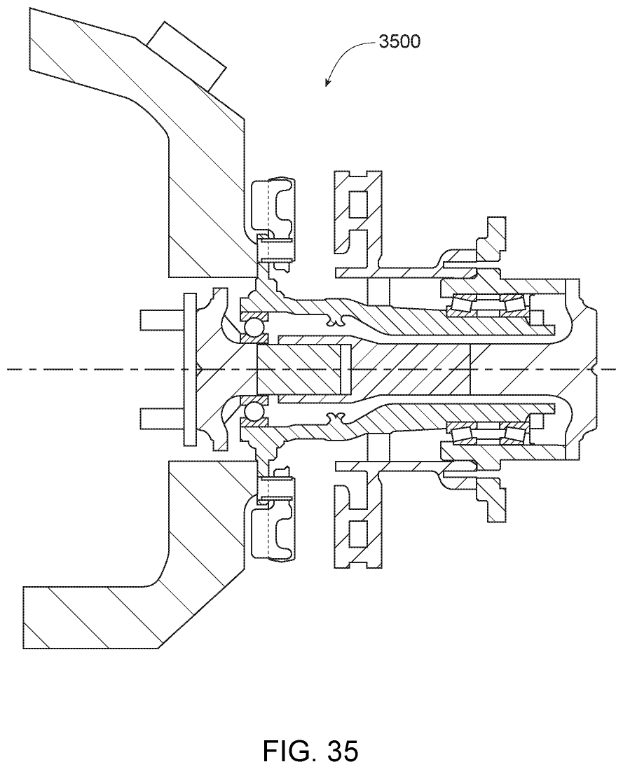

FIG. 35 shows a cross-sectional view of a wheel assembly 3500 for the vehicle 100 that can be used with the electric axle 110. It should be recognized that other types of wheel assemblies 3500 can be used in other examples.

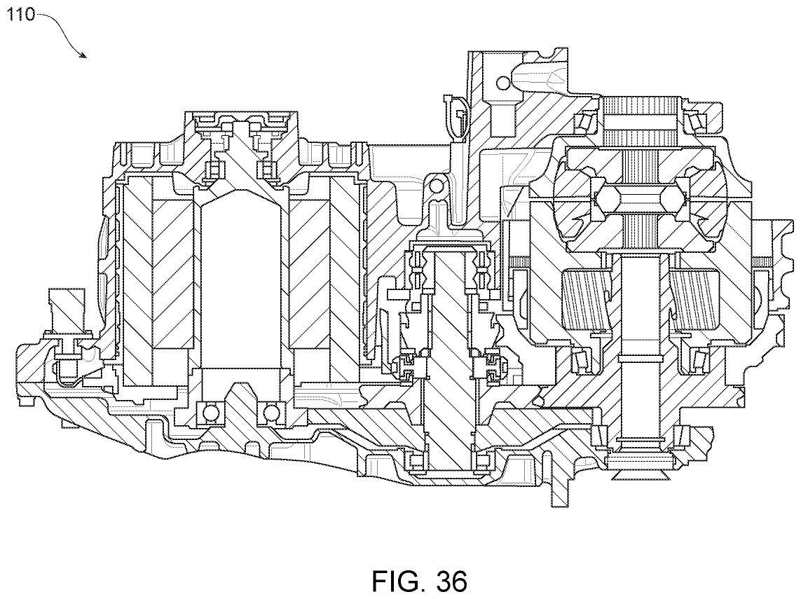

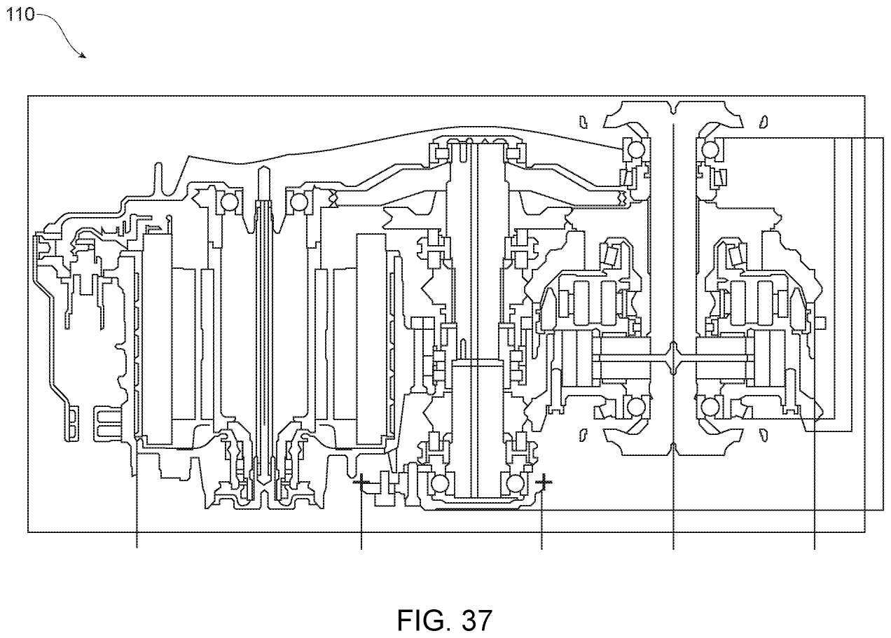

FIGS. 36 and 37 show some cross-sectional views of the electric axle 110. As can be seen, the electric axle 110 has been designed to fit within the tight confines underneath the vehicle 100. For example, the electric axle 110 has been designed to be relatively narrow. Moreover, the layout of the electric axle 110 has been designed to reduce the risk of damage caused by debris impacts or other impacts.

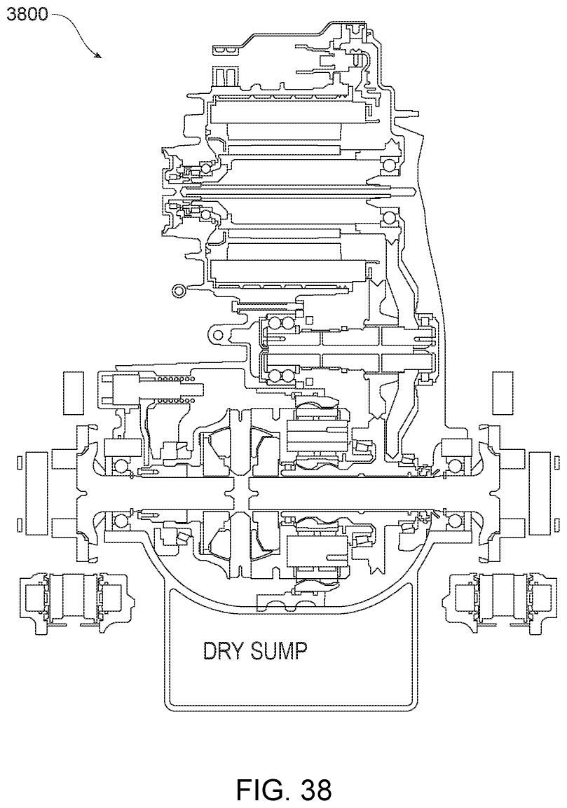

FIG. 38 is a cross-sectional view of an electric axle 3800 according to another example. Like in the other examples, the electric axle 3800 is configured to provide a compact design for the vehicle 100. Moreover, the layout of the electric axle 3800 is further configured to promote modularity.

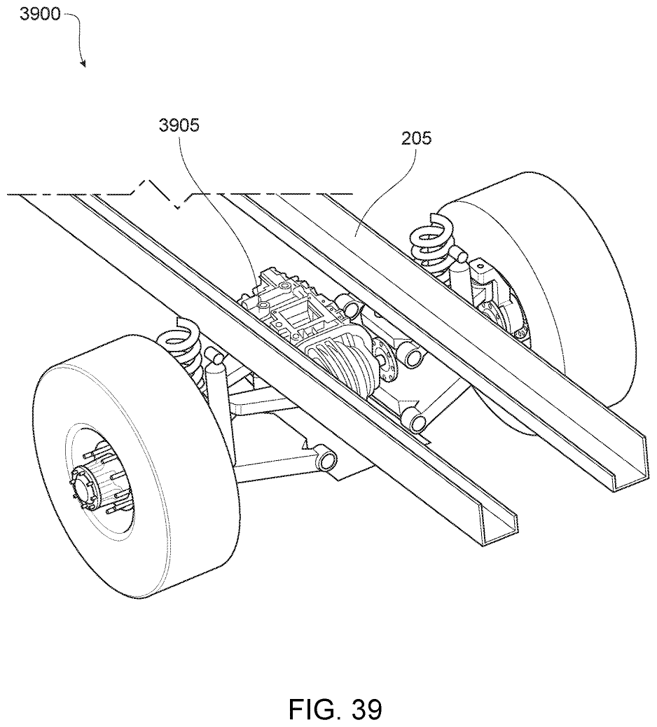

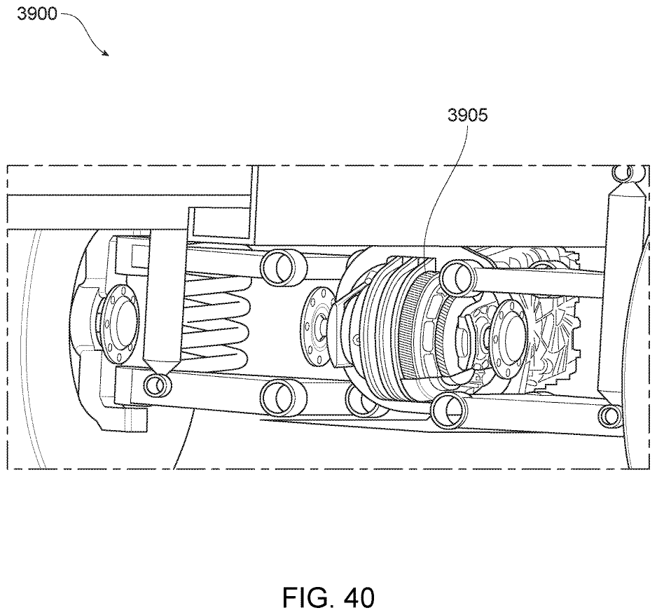

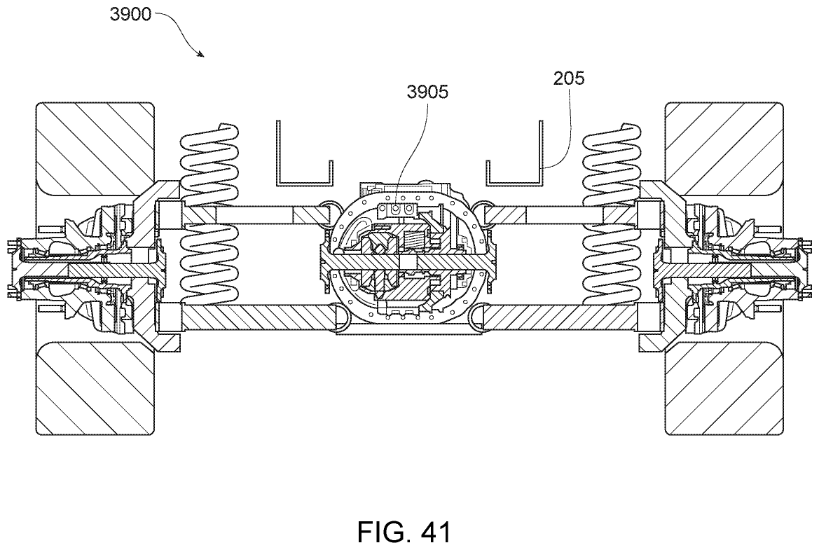

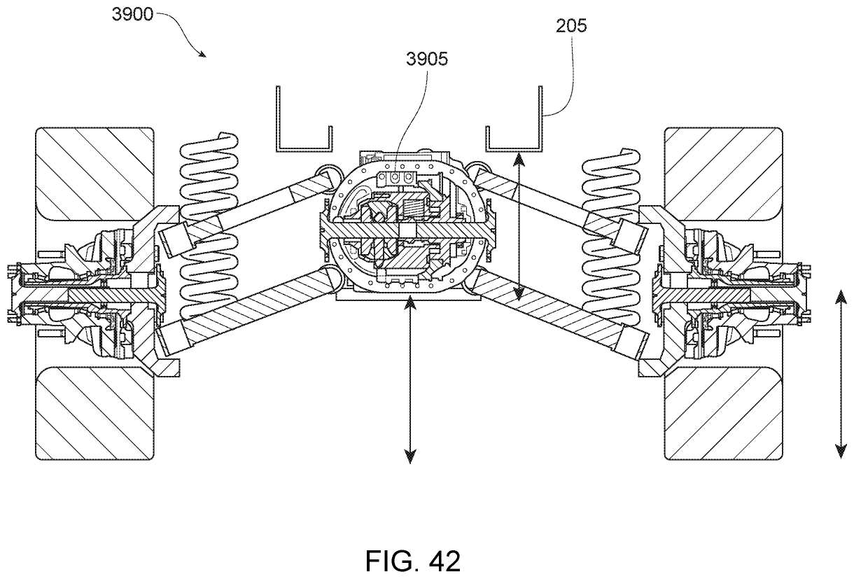

FIGS. 39, 40, 41, and 42 show several views of a vehicle system 3900 that includes an electric axle 3905 according to another variation. As shown, the electric axle 3905 is secured to the chassis 205 of the vehicle 100. The electric axle 3905 operates in a fashion similar to the electric axle 110 described above. For example, the electric axle 3905 in FIG. 39 can replace one or more of the electric axles 110 shown in FIG. 1.

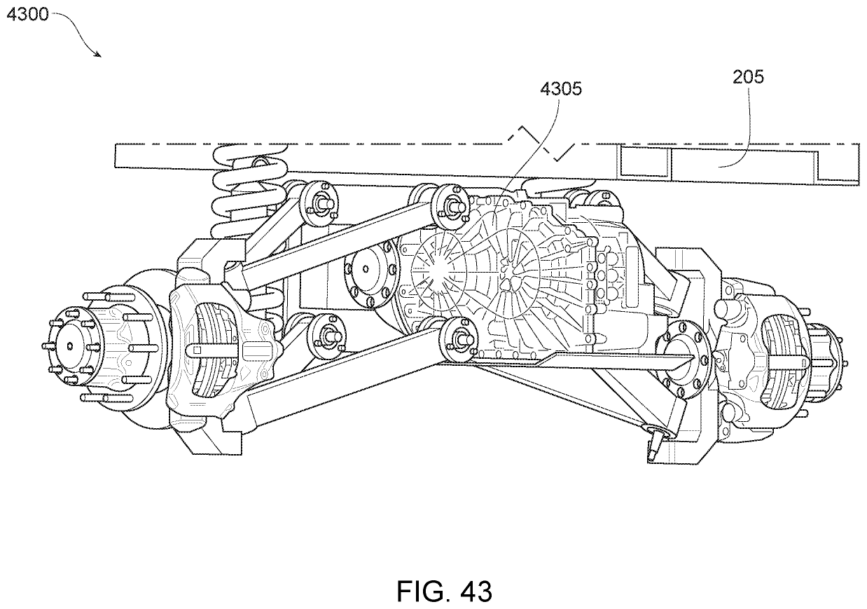

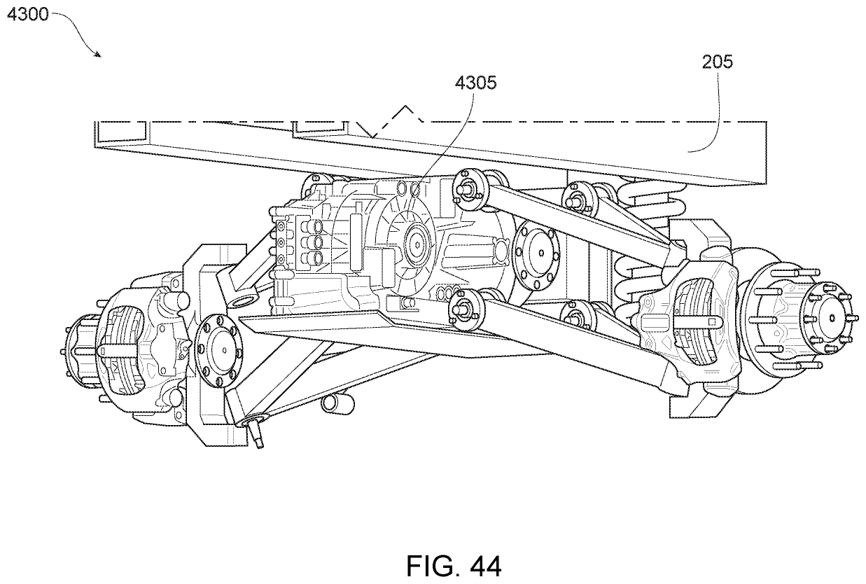

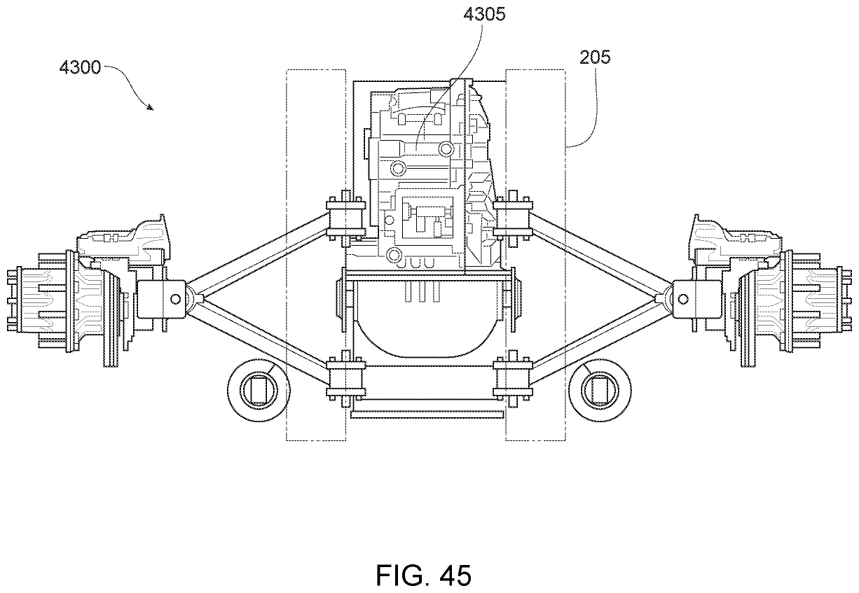

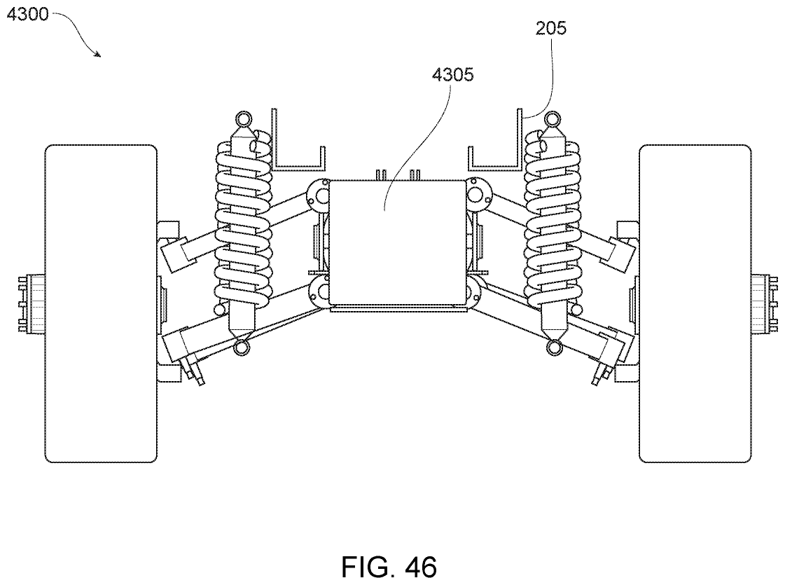

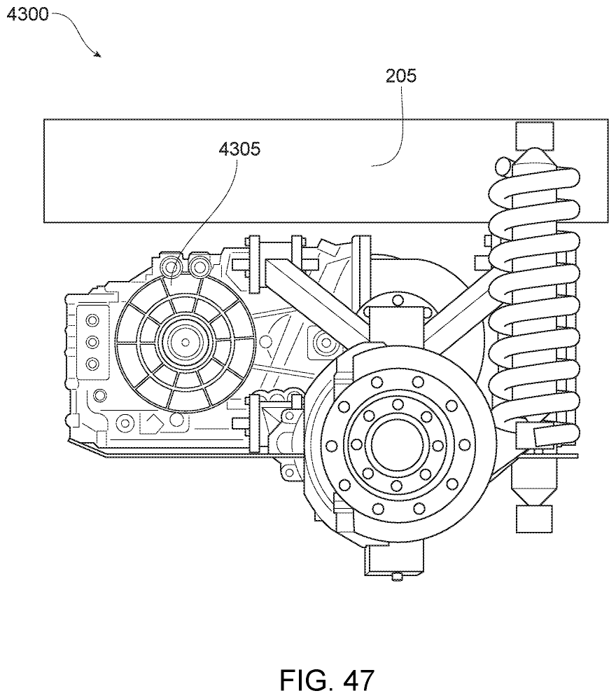

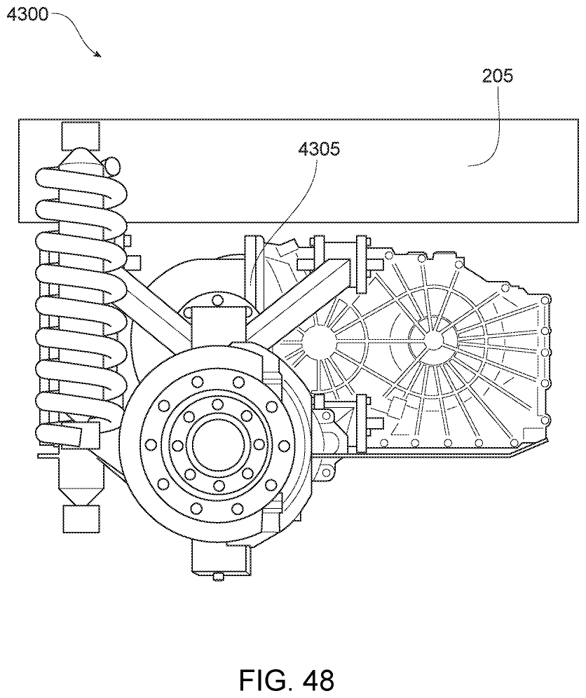

FIGS. 43, 44, 45, 46, 47, and 48 show a number of views of a vehicle system 4300 that includes an electric axle 4305 according to still yet another variation. As shown, the electric axle 4305 is secured to the chassis 205 of the vehicle 100. The electric axle 4305 operates in a fashion similar to the electric axle 110 and the electric axle 3905 of the type described before. For example, the electric axle 4305 in FIG. 43 can replace one or more of the electric axles 110 shown in FIG. 1.

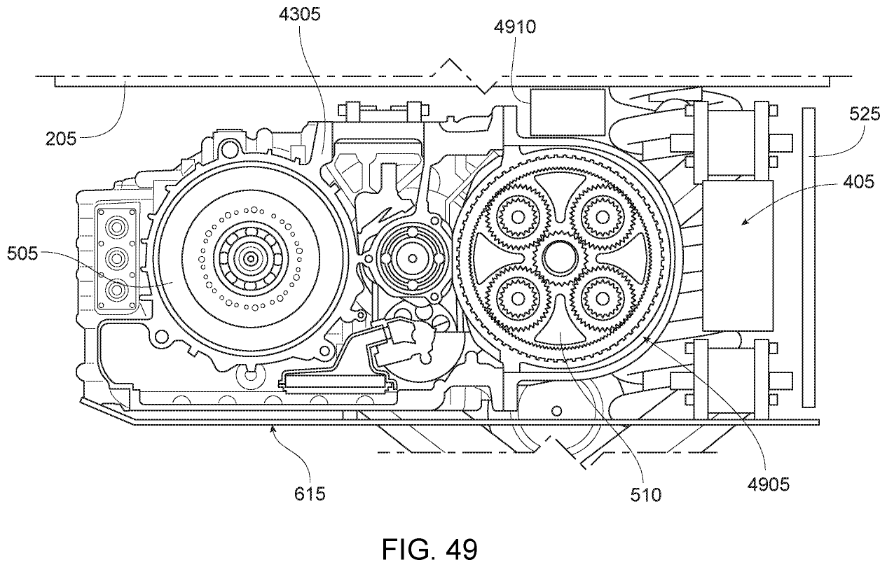

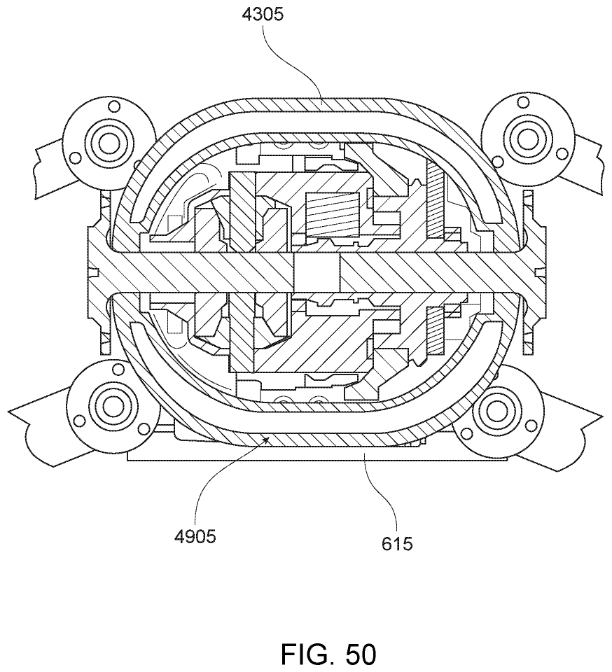

Turning to FIGS. 49 and 50, the electric axle 4305 shares most components in common with the previously describe electric axle 110 of FIG. 4 and the electric axle 3905 of FIG. 39. For example, the electric axle 4305 includes the inverter 405, the e-machine 505, the transmission 510, the protection plate 525, and the sump guard 615. For the sake of brevity as well as clarity, these common components and their function will not be again described in great detail, but please refer to the previous discussion of these components. Like in the other examples, the protection plate 525 is positioned proximal to the inverter 405 to protect the inverter 405 as well as other components of the electric axle 4305 from projectiles, and the sump guard 615 is positioned to protect the underside of the electric axle 4305 from debris. The electric axle 4305 further has a rear cover 4905 that partially wraps around the transmission 510 to further protect the transmission 510. In the depicted example, the electric axle 4305 further includes an electronic control unit (ECU) 4910 located proximal to the rear cover 4905 for controlling the operation of the electric axle 4305 as well as other components of the vehicle 100. Having the ECU 4910 incorporated into the electric axle 4305 further promotes the modular nature of the electric axle 4305 so as to for example facilitate swapping of the electric axles 4305.

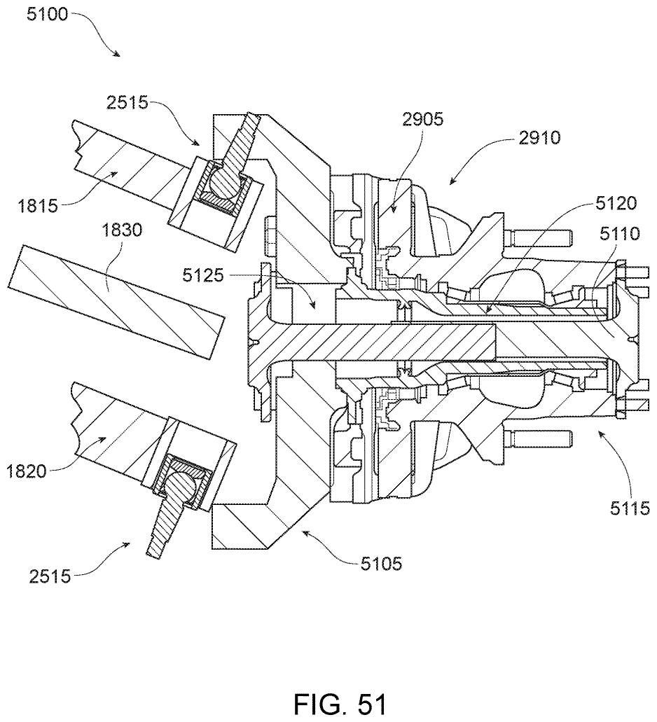

FIG. 51 shows a cross-sectional view of an upright assembly 5100 that can be used for the wheels of the vehicle 100. For example, the assembly 5100 can be used in conjunction with the electric axle 110 of FIG. 4, the electric axle 3905 of FIG. 35, and/or the electric axle 4305 of FIG. 43 to rotate the wheels of the vehicle 100. The assembly 5100 shares a number of components in common with the previously described examples. For instance, the assembly 5100 includes the upper suspension arm 1815, the lower suspension arm 1820, the drive shaft 1830, the steering knuckles 2515, the rotor 2905, and the brake caliper 2910 of the type described before. In one form, the brake caliper 2910 is a pneumatic type brake caliper 2910, but the brake caliper 2910 in other forms can include other types, such as those hydraulically and/or electrically actuated. For the sake of brevity as well as clarity, these common components will not be again described in great detail, but please refer to the previous discussion of these common features.

As can be seen, the assembly 5100 includes a steering capable upright 5105, a two-piece center spindle 5110 located at a wheel end 5115, and a bolt on spindle 5120. The center spindle 5110 extends through both the upright 5105 and the bolt on spindle 5120. The assembly 5100 further has a bearing 5125 disposed between the upright 5105 and the center spindle 5110 to reduce friction and provide a seal.

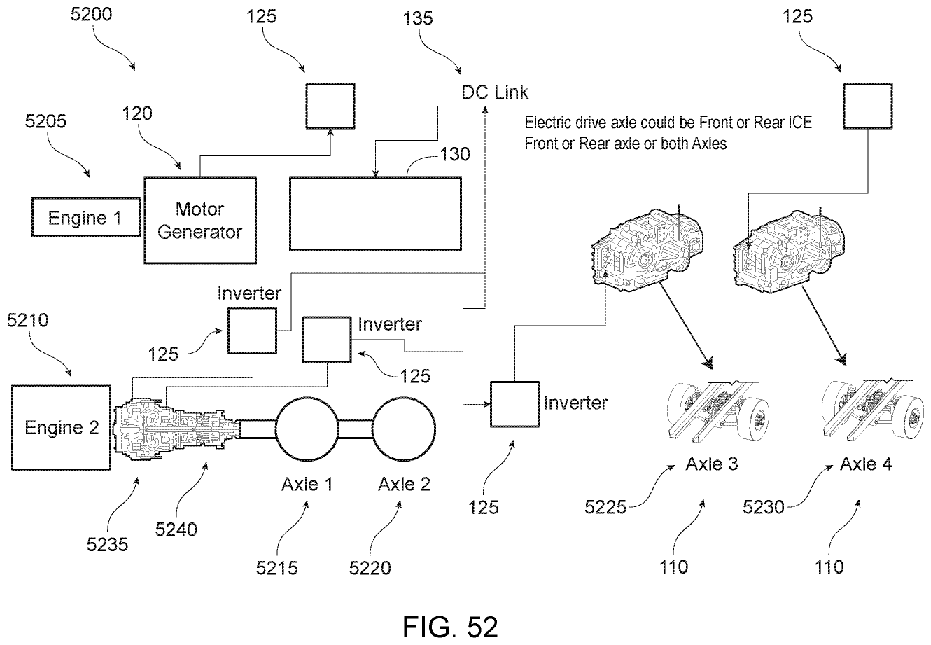

FIG. 52 shows a diagram of an electric power system 5200 that is configured to power an 8×8 type vehicle 100. The system 5200 uses a split powertrain. In one form, the system 5200 includes a series hybrid diesel engine arrangement in conjunction with an inline series/parallel/mechanical hybrid system. As can be seen, the system 5200 shares a number of components in common with the previously described systems. For example, the system 5200 includes the electric axles 110, the e-machine 120, the inverters 125, the ESS 130, and the DC link 135. For the sake of brevity as well as clarity, these common features will not be again described in great detail, but please refer to the previous discussions.

The system 5200 includes two internal combustion engines, a first engine 5205 and a second engine 5210. The vehicle 100 for the system 5200 has a first axle 5215, a second axle 5220, a third axle 5225, and a fourth axle 5230. The first engine 5205 drives the e-machine 120, and the e-machine 120 produces electrical energy that powers the electric axles 110 at the third axle 5225 and the fourth axle 5230. While the system 5200 in FIG. 52 will be described with reference to the electric axle 110 of FIG. 4, it should be recognized that the other electric axles, like the FIG. 39 electric axle 3905 and the FIG. 43 electric axle 4305, can be used in the system 5200. The second engine 5210 produces mechanical power to drive an e-machine 5235 and a transmission 5240 located between the second engine 5210 and the first axle 5215. The e-machine 5235 can produce electrical power, such as via operation of the second engine 5210 and/or during regenerative braking, that can be stored in the ESS 130 or used by the electric axles 110. Likewise, electrical power stored in the ESS 130 can be used to power the e-machine 5235, which in turn mechanically drives the first axle 5215 and the second axle 5220. In some or most operational cases, the mechanical power of the second engine 5210 is transmitted through the transmission 5240 to mechanically drive the first axle 5215 and the second axle 5220. The transmission 5240 can be used to change the speed and torque from the second engine 5210. It should be recognized that the system 5200 in FIG. 52 provides mechanical and electrical redundancy so that the vehicle 100 is still able to limp home even when significant components are damaged or destroyed, which can be helpful for military as well as other types of vehicles.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“And/Or” generally refers to a grammatical conjunction indicating that one or more of the cases it connects may occur. For instance, it can indicate that either or both of the two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Axis” generally refers to a straight line about which a body, object, and/or a geometric figure rotates or may be conceived to rotate.

“Ball Joint” or “Ball-and-Socket Joint” generally refers to a mechanical device that allows free rotation in two or more planes at the same time while substantially preventing translation motion in any direction. The ball joint for example includes a spherical knob or knoblike part that fits into a cavity or socket of another part. In one version, the ball joint includes a bearing stud and socket attached in a casing.

“Battery” generally refers to a device that converts chemical energy into electrical energy. The battery stores energy in chemical form and then discharges the energy by converting chemical energy into electricity. The battery generally includes one or more electrochemical cells and terminals. The terminals usually include an anode and a cathode.

“Bearing” generally refers to a machine element that constrains relative motion and reduces friction between moving parts to only the desired motion, such as a rotational movement. The bearing for example can be in the form of loose ball bearings found in a cup and cone style hub. The bearing can also be in the form of a cartridge bearing where ball bearings are contained in a cartridge that is shaped like a hollow cylinder where the inner surface rotates with respect to the outer surface by the use of ball or other types of bearings.

“Brake” generally refers to a device for arresting and/or preventing the motion of a mechanism usually via friction, electromagnetic, and/or other forces. Brakes for example can include equipment in automobiles, bicycles, or other vehicles that are used to slow down and/or stop the vehicle. In other words, a brake is a mechanical device that inhibits motion by absorbing energy from a moving system. The brake can be for example used for slowing or stopping a moving vehicle, wheel, and/or axle, or to prevent its motion. Most often, this is accomplished by friction. Types of brakes include frictional, pressure, and/or electromagnetic type braking systems. Frictional brakes for instance can include caliper, drum, and/or disc drakes. Electromagnetic braking systems for example can include electrical motor/generators found in regenerative braking systems.

“Chassis” generally refers to a load-bearing structural framework of a vehicle that directly or indirectly supports all other components of the vehicle, including (but not limited to) the motor, transmission, suspension, and body. In body-on-frame vehicles, the chassis is a separate, rigid frame providing primary structural support for a separate body of the vehicle as well as the other components of the vehicle. In other words, the chassis in a body-on-frame vehicle is a distinct, rigid frame upon which the body of the vehicle is mounted so as to provide the primary structural support. Body-on-frame vehicles are commonly used in heavy-duty type applications. In unibody vehicles, the functions of the frame and the body are integrated into a single chassis structure that provides enhanced rigidity and fuel efficiency. To say it another way, the chassis and body are integrated into a single, cohesive structure in a unibody type vehicle, where the body panels themselves contribute significantly to the overall strength and rigidity of the vehicle. In both types of vehicle designs, the chassis serves as the main attachment point for components like receiver hitches.

“Clutch” generally refers to a device that engages and disengages mechanical power transmission between two or more rotating shafts or other moving components. In one example, one shaft is typically attached to an engine, motor, or other power source, which acts as the driving member, while the other shaft (i.e., the driven member) provides output power for work. While the motions involved are usually rotary motions, linear clutches are also used to engage and disengage components moving with a linear or near linear motion. The clutch components can for instance be engaged and disengaged through mechanical, hydraulic, and/or electrical actuation. The clutches can include positive type clutches and friction type clutches. Wet type clutches are typically immersed in a cooling lubrication liquid or other fluid, and dry clutches are not bathed in such liquids. Some non-limiting examples of clutches include cone clutches, centrifugal clutches, torque limiter clutches, axial clutches, disc clutches, dog clutches, and rim clutches, to name just a few.

“Cogwheel”, “Cog”, or “Pinion” generally refers to a relatively small gear in a gear drive train. The cogwheel usually include a series of teeth that engage corresponding teeth on a rack or other teethed structure. Typically, but not always, the smaller cogwheel engages or is engaged inside a larger gear or to a rack. When engaging a rack, rotational motion applied to the cogwheel causes the rack to move relative to the cogwheel, thereby translating the rotational motion of the cogwheel into linear motion. By way of non-limiting examples, the cogwheel can be incorporated into differential, rack-and-pinion, and clutch bell drive trains, to name just a few. The cogwheel can be oriented in a number of manners relative to the larger gear or rack. For instance, the cogwheel can be angled perpendicular to a crown gear in a differential type drive.

“Conductor” or “Conductive Material” generally refers to a material and/or object that allows the free flow of an electrical charge in one or more directions such that relatively significant electric currents will flow through the material under the influence of an electric field under normal operating conditions. By way of non-limiting examples, conductors include materials having low resistivity, such as most metals (e.g., copper, gold, aluminum, etc.), graphite, and conductive polymers.

“Controller” generally refers to a device, using mechanical, hydraulic, pneumatic electronic techniques, and/or a microprocessor or computer, which monitors and physically alters the operating conditions of a given dynamical system. In one non-limiting example, the controller can include an Allen Bradley brand Programmable Logic Controller (PLC). A controller may include a processor for performing calculations to process input or output. A controller may include a memory for storing values to be processed by the processor, or for storing the results of previous processing. A controller may also be configured to accept input and output from a wide array of input and output devices for receiving or sending values. Such devices include other computers, keyboards, mice, visual displays, printers, industrial equipment, and systems or machinery of all types and sizes. For example, a controller can control a network or network interface to perform various network communications upon request. The network interface may be part of the controller or characterized as separate and remote from the controller. A controller may be a single, physical, computing device such as a desktop computer, or a laptop computer, or may be composed of multiple devices of the same type such as a group of servers operating as one device in a networked cluster, or a heterogeneous combination of different computing devices operating as one controller and linked together by a communication network. The communication network connected to the controller may also be connected to a wider network such as the Internet. Thus, a controller may include one or more physical processors or other computing devices or circuitry and may also include any suitable type of memory. A controller may also be a virtual computing platform having an unknown or fluctuating number of physical processors and memories or memory devices. A controller may thus be physically located in one geographical location or physically spread across several widely scattered locations with multiple processors linked together by a communication network to operate as a single controller. Multiple controllers or computing devices may be configured to communicate with one another or with other devices over wired or wireless communication links to form a network. Network communications may pass through various controllers operating as network appliances such as switches, routers, firewalls or other network devices or interfaces before passing over other larger computer networks such as the Internet. Communications can also be passed over the network as wireless data transmissions carried over electromagnetic waves through transmission lines or free space. Such communications include using Wi-Fi or other Wireless Local Area Network (WLAN) or a cellular transmitter/receiver to transfer data.

“Controller Area Network” or “CAN” generally refers to a vehicle bus standard designed to allow microcontrollers, sensors, and/or other devices to communicate with each other in applications without necessarily a host computer. CAN systems include a message-based protocol, designed originally for multiplex electrical wiring within automobiles, but is also used in many other contexts. A vehicle with a CAN system may normally, but not always, includes multiple Electronic Control Units (ECUs) which can be also called nodes. These ECUs can include Engine Control Modules (ECMs) and Transmission Control Modules (TCMs) as well as other control units such as for airbags, antilock braking/ABS, cruise control, electric power steering, audio systems, power windows, doors, mirror adjustment, battery and/or hybrid/electric recharging systems, to name just a few. A CAN includes a multi-master serial bus standard for connecting ECUs. The complexity of the ECU or node can range from a simple Input/Output (I/O) device up to an embedded computer with a CAN interface and software. The ECU or node can also act as a gateway allowing a general-purpose computer to communicate over an interface, such as via a USB and/or Ethernet port, to the devices on the CAN network. Each ECU usually, but not always, includes a central processing unit, a CAN controller, and transceiver. The CAN systems can for example include low speed CAN (128 Kbps) under the ISO 11898-3 standard, high speed CAN (512 Kbps) under the ISO 11898-2 standard, CAN FD under the ISO 11898-1 standard, and single wire CAN under the SAE J2411 standard.

“Cradle” generally refers to a structure or component designed to support or securely hold another object. The shape of a cradle often includes curved or contoured surfaces that conform to the object being supported, allowing it to nestle or rest securely within the cradle.

“Crumple Zone” generally refers to a structural component of a product designed to increase the time over which a change in velocity occurs as a result of an impact and/or force. In one example, crumple zones are configured to deform in a predetermined manner to control and/or absorb a portion of the applied force, thus reducing the impact felt by passengers. In another example, crumple zones are configured to deform in a particular location in order to re-direct force from an impact.

“Eccentric” generally refers to having an axis located elsewhere than at the geometric center of an object or relative an axis of another object. As one non-limiting example, when oriented in an eccentric manner, the object has an axis of revolution displaced from the center of the object (or relative to another object) so that the object is capable of imparting reciprocating motion. In other words, something is considered eccentric when it is not placed centrally or does not have its axis or other part placed centrally.

“Electric Machine” or “E-Machine” generally refers to a device that converts electrical energy into mechanical energy and/or vice versa. For example, electric machines generally include electric motors and electric generators. Normally, but not always, electric machines operate through the interaction between one or more magnetic fields in the electric machine and winding currents to generate force in the form of rotation and/or generate electrical energy in response to rotation. Electric machines, as a motor, can be powered by direct current (DC) sources, such as from batteries, motor vehicles, and/or rectifiers, or by alternating current (AC) sources, such as a power grid, inverters, and/or electrical generators. Electric machines, as a generator, can produce electrical energy as a DC source or as an AC source. Additionally, circuitry incorporated into the electric machine can convert between DC and AC electrical power. In some cases, an electric generator can be mechanically identical to an electric motor, but operate in the reverse direction, accepting mechanical energy and converting the mechanical energy into electrical energy. To name a few examples, electric machines can include induction machines, synchronous machines, brushless DC machines, brushed DC machines, switched reluctance machines, stepper machines, and/or linear electric machines among other examples.

“Electric Motor” generally refers to an electrical machine that converts electrical energy into mechanical energy. Normally, but not always, electric motors operate through the interaction between one or more magnetic fields in the motor and winding currents to generate force in the form of rotation. Electric motors can be powered by direct current (DC) sources, such as from batteries, motor vehicles, and/or rectifiers, or by alternating current (AC) sources, such as a power grid, inverters, and/or electrical generators. An electric generator can (but not always) be mechanically identical to an electric motor, but operates in the reverse direction, accepting mechanical energy and converting the mechanical energy into electrical energy.

“Electrical Connection” generally refers to a connection between two objects that allows a flow of electric current and/or electric signals.

“Electrically Connected” generally refers to a configuration of two objects that allows electricity to flow between them or through them. In one example, two conductive materials are physically adjacent one another and are sufficiently close together so that electricity can pass between them. In another example, two conductive materials are in physical contact allowing electricity to flow between them.

“Electronic Control Unit (ECU)” or “Electronic Control Module (ECM)” generally refers to an embedded system in electronics of a vehicle that controls one or more electrical systems and/or subsystems of the vehicle. Usually, but not always, ECUs communicate over a Controller Area Network (CAN) and can act as nodes over the CAN. The complexity of the ECU or node can range from a simple Input/Output (I/O) device up to an embedded computer with a CAN interface and software. The ECU or node can also act as a gateway allowing a general purpose computer to communicate over an interface, such as via a USB and/or Ethernet port, to the devices on the CAN network. Each ECU usually, but not always, includes a central processing unit, a CAN controller, and a transceiver. These ECUs can for instance include Engine Control Modules (ECMs) and Transmission Control Modules (TCMs) as well as other control units such as for airbags, antilock braking/ABS, cruise control, electric power steering, audio systems, power windows, doors, mirror adjustment, battery and/or hybrid/electric recharging systems, to name just a few. By way of nonlimiting examples, types of ECUs can include ECMs, TCMs, Powertrain Control Module (PCMs), Brake Control Modules (BCMs or EBCMs), Central Control Modules (CCMs), Central Timing Modules (CTMs), General Electronic Modules (GEMs), Body Control Modules (BCMs), and/or Suspension Control Modules (SCMs), to name just a few.

“Energy Source” generally refers to a device, structure, mechanism, and/or system that provides power for performing work. The energy supplied by the energy source can take many forms including electrical, chemical, electrochemical, nuclear, hydraulic, pneumatic, gravitational, kinetic, and/or potential energy forms. The energy source for instance can include ambient energy sources, such as solar panels, external energy sources, such as from electrical power transmission networks, and/or portable energy sources, such as batteries. The energy source can include an energy carrier containing energy that can be later converted to other forms, such as into mechanical, heat, electrical, and/or chemical forms. Energy carriers can for instance include springs, electrical batteries, capacitors, pressurized air, dammed water, hydrogen, petroleum, coal, wood, and/or natural gas, to name just a few.

“Energy Storage System” (ESS) or “Energy Storage Unit” generally refers to a device that captures energy produced at one time for use at a later time. The energy can be supplied to the ESS in one or more forms, for example including radiation, chemical, gravitational potential, electrical potential, electricity, elevated temperature, latent heat, and kinetic types of energy. The ESS converts the energy from forms that are difficult to store to more conveniently and/or economically storable forms. By way of non-limiting examples, techniques for accumulating the energy in the ESS can include: mechanical capturing techniques, such as compressed air storage, flywheels, gravitational potential energy devices, springs, and hydraulic accumulators; electrical and/or electromagnetic capturing techniques, such as using capacitors, super capacitors, and superconducting magnetic energy storage coils; biological techniques, such as using glycogen, biofuel, and starch storage mediums; electrochemical capturing techniques, such as using flow batteries, rechargeable batteries, and ultra-batteries; thermal capture techniques, such as using eutectic systems, molten salt storage, phase-change materials, and steam accumulators; and/or chemical capture techniques, such as using hydrated salts, hydrogen, and hydrogen peroxide. Common ESS examples include lithium-ion batteries and super capacitors.

“Fastener” generally refers to a hardware device that mechanically joins or otherwise affixes two or more objects together. By way of non-limiting examples, the fasteners can include bolts, dowels, nails, nuts, pegs, pins, rivets, and screws, to just name a few.

“Fluid” generally refers to a substance that does not have a fixed shape. For example, a fluid includes a liquid and/or a gas. Typically, fluids are able to flow easily, such as air flowing over a wing, blood flowing through a circulatory system, water flowing through plumbing, or oil flowing through a motor as examples. In some cases, a fluid refers to a mixture of solids, liquids, and/or gases. For example, a slurry of solids and water, liquid droplets mixed with air, aerated solid particles, a mixture of solids with liquids and gases, and/or other mixtures of different materials may be fluids.

“Frame” generally refers to a rigid structural foundation of a body-on-frame vehicle. In the body-on-frame vehicle, the frame and body are separate components that are assembled together. The frame provides the primary support for the motor, transmission, suspension, and/or body. Unlike a unibody construction where the chassis and body are integrated, the frame in a body-on-frame vehicle is a separate entity to which all major components are attached. The frame normally is designed to handle heavy loads and stresses which make the body-on-frame design suitable for trucks and off-road vehicles.

“Gas Spring”, “Gas Strut”, or “Pneumatic Spring” generally refers to a type of spring that uses the compressibility of a gas contained within an enclosed container to store potential energy as well as to exert a force and provide controlled movement. Unlike a traditional mechanical spring that uses elastic deformation to store energy, a gas spring uses the compressibility of a gas, such as nitrogen. This allows gas springs to provide a more consistent and predictable force over longer stroke lengths. In one example, the compressed gas is contained within an enclosed cylinder or barrel. The cylinder is sealed by a sliding piston and/or piston rod to pneumatically store potential energy and generally withstand external, longitudinal forces applied to the piston rod. In one version, the piston separates the cylinder into two chambers, one filled with the gas and the other filled with another fluid, like liquid oil. As the force is applied to the piston rod, the gas in the cylinder compresses, forcing the oil through a small orifice. This controlled flow of oil creates a damping effect, which slows down the movement of the piston rod and provides a smooth and controlled motion.

“Gear Train” generally refers to a system of gears that transmit power from one mechanical component to another. For example, a gear train can include a combination of two or more gears, mounted on rotating shafts, to transmit torque and/or power. As one non-limiting example, the gear train for instance can include a planetary gearset.

“Housing” generally refers to a component that covers, protects, and/or supports another thing. A housing can have a unitary construction or be made of multiple components. The housing can be made from the same material or a combination of different materials. The housing can include a protective cover designed to contain and/or support one or more mechanical components. Some non-limiting examples of a housing include a case, enclosure, covering, body, and shell.

“Insulator” or “Insulative Material” generally refers to a material and/or object whose internal electric charges do not flow freely such that very little electric current will flow through the material under the influence of an electric field under normal operating conditions. By way of non-limiting examples, insulator materials include materials having high resistivity, such as glass, paper, ceramics, rubber, and plastics.

“Integrally Formed” generally refers to a component and/or multiple components that are fused into a single piece. Integrally formed components are incapable of being dismantled without destroying the integrity of the component.

“Internal Combustion Engine” or “ICE” generally refers to a device that produces mechanical energy by combusting fuel in a confined space. Internal combustion engines are generally a type of heat engine that converts chemical and/or thermal energy into mechanical energy. Combustion within the internal combustion engine commonly occurs by mixing fuel with an oxidizer, such as air, in a combustion chamber. The fuel mixture is then ignited through a spark and/or by compressing the fuel mixture as a couple examples. The combustion process typically generates high-pressure, high-temperature gases that apply forces directly to engine components to move, such as pistons, rotors, and/or turbine blades. The internal combustion engine is typically configured to produce rotational and/or linear mechanical force at the output. To name a few examples, internal combustion engines can include a reciprocating piston engine, a gas turbine, a Wankel engine, a two-stroke engine, a four-stroke engine, an opposed-piston engine, a Stirling engine, Atkinson cycle engine, and/or Miller cycle engine among other examples. The fuel used in combustion can include gasoline, diesel, natural gas, ethanol, methanol, jet fuel, hydrogen, and/or other types of fuel.

“Inverter” or “Power Inverter” generally refers to an electronic device and/or circuitry that at least converts direct current (DC) to alternating current (AC). Certain types of inverters can further include a rectifier that converts AC to DC such that the inverter and rectifier functions are combined together to form a single unit that is sometimes referred to as an inverter. The inverter can be entirely electronic or may be a combination of mechanical devices, like a rotary apparatus, and electronic circuitry. The inverter can further include static type inverters that do not use moving parts to convert DC to AC.

“Lateral” generally refers to being situated on, directed toward, or coming from the side.

“Longitudinal” generally refers to the length or lengthwise dimension of an object, rather than across.

“Lubricant” generally refers to a substance that is used to reduce friction between the surfaces of rotating or moving objects. For example, a lubricant may be an oil or grease that is used to reduce friction between ball bearings, interlocking gears, and/or other rotating parts in a motor or engine. In addition to reducing friction, lubricants may be used for other purposes. For example, lubricants may cool surfaces, transport particles, transmit forces, and/or perform other functions.

“Metallic” generally refers to a material that includes a metal or is predominately (50% or more by weight) a metal. A metallic substance may be a single pure metal, an alloy of two or more metals, or any other suitable combination of metals. The term may be used to refer to materials that include nonmetallic substances. For example, a metallic cable may include one or more strands of wire that are predominately copper sheathed in a polymer or other nonconductive material.

“Motor” generally refers to a machine that supplies motive power for a device with moving parts. The motor can include rotor and linear type motors. The motor can be powered in any number of ways, such as via electricity, internal combustion, pneumatics, and/or hydraulic power sources. By way of non-limiting examples, the motor can include a servomotor, a pneumatic motor, an electric motor, a hydraulic motor, a steam engine, a pneumatic piston, a hydraulic piston, and/or an internal combustion engine.

“Or” generally refers to a conjunction that is indicative of two or more alternatives. In other words, the word “or” connects words, phrases, and/or clauses that offer different possibilities. Usually, but not always, the word “or” only appears before the last alternative in a series of alternatives.

“Planetary Gear” or “Planetary Gearset” generally refers to a system of at least two gears mounted so that the center of at least one gear revolves around the center of the other. In other words, the planetary gear includes a system of epicyclic gears in which at least one gear axis revolves about the axis of another gear. In one example, a carrier connects the centers of the two gears and rotates to carry one gear, which is called a planet gear, around the other, which is commonly called a sun gear. Typically, but not always, the planet and sun gears mesh so that their pitch circles roll without slip. A point on the pitch circle of the planet gear normally traces an epicycloid curve. In one simplified case, the sun gear is fixed and the one or more planet gears roll around the sun gear. In other examples, an epicyclic gear train can be assembled so the planet gear rolls on the inside of the pitch circle of a fixed, outer gear ring, or ring gear, that is sometimes called an annular gear. In this case, the curve traced by a point on the pitch circle of the planet gear is a hypocycloid. A planetary gear is typically used to transfer large torque loads in a compact form.

“Positive Clutch” generally refers to a type of clutch that is designed to transmit torque without slippage such as through a mechanical interference type connection. Some examples of positive clutches include jaw clutches (e.g., square or spiral jaw clutches) and dog clutches.

“Power Distribution System” generally refers to a network that is configured to deliver power to one or more loads. Power distribution networks may transfer any type of power. A common example is an electric power distribution system. In electric power distribution, power can be transferred across electrically conductive materials or can be transmitted wirelessly through electromagnetic fields. The distribution system can deliver power obtained from one or more energy storage devices or external power distribution or transmission networks. Similarly, the loads can include one or more energy storage devices, external power distribution or transmission networks, or devices that consume power.

“Power Take-Off (PTO)” or “PTO Unit” generally refers to a device that transfers power from an engine and/or motor of a vehicle to an external device. PTOs are commonly used to power a variety of accessories, such as winches, pumps, and generators in heavy duty vehicles.

“Powertrain” generally refers to devices and/or systems used to transform stored energy into kinetic energy for propulsion purposes. The powertrain can include multiple power sources and can be used in non-wheel-based vehicles. By way of non-limiting examples, the stored energy sources can include chemical, solar, nuclear, electrical, electrochemical, kinetic, and/or other potential energy sources. For example, the powertrain in a motor vehicle includes the devices that generate power and deliver the power to the road surface, water, and/or air. These devices in the powertrain include engines, electric motors, transmissions, drive shafts, differentials, and/or final drive components (e.g., drive wheels, continuous tracks, propeller, thrusters, etc.).

“Radially Outward” generally refers to a relative position that is positioned at a greater distance from a defined center point or axis. An object may be extending radially outward if the object has a starting point at a given distance from the defined center or axis and then moves farther away from that center point or axis.

“Resolver” generally refers to a type of rotary sensor for measuring the degree of rotation, velocity, and/or acceleration of a rotary type device. In one example, the resolver includes a rotary electrical transformer used for measuring degrees of rotation such as in an electric motor, an electric generator, and/or a transmission. The resolver can include analog or digital type electrical devices. The resolver can be in the form of a two-pole type resolver or a multi-pole type resolver. Some other types of resolvers include receiver type resolvers and differential type resolvers.

“Rotate” generally refers to turning or movement about an axis and/or center. In some examples, the axis and/or center may be a fixed point. A more technical definition may include, to cause a plane region, line, and/or object to sweep out a volume or surface by moving around an axis so that each of its points remain at a constant distance from the axis. As an example, the earth rotates about a center axis. As another example, a pin joint allows movement via rotation about a single axis formed by the pin.

“Rotor” generally refers to a part or portion in a machine that rotates in or around a stationary part, which is commonly referred to as a stator. The rotor is the moving or rotating part of a rotary system, such as found in electric generators, electric motors, sirens, mud motors, turbines, and/or biological rotors. In one particular non-limiting example, the rotor includes the rotating portion of an electric generator and/or motor, especially of an induction motor.

“Shaft” generally refers to a part that rotates about a central axis. Shafts are a part of various mechanically rotating devices, such as motors, engines, transmissions, gearsets, and/or other devices. Shafts are usually, but not always, used to transfer mechanical torque between various mechanical components. For example, the shaft of a motor may transfer energy to a transmission, an axle, a wheel, and/or another device. In some cases, the shaft of a device is integrated with other parts of that device. The shaft can be shaped in any number of manners. For instance, the shaft can have a cylindrical or rectangular shape, and the shaft can be hollow or solid.

“Spring” generally refers to an elastic object that stores mechanical energy. The spring can include a resilient device that can be pressed, pulled, and/or twisted but returns to its former shape when released. The spring can be made from resilient or elastic material such as metal and/or plastic. The spring can counter or resist loads in many forms and apply force at constant or variable levels. For example, the spring can include a tension spring, compression spring, torsion spring, constant spring, and/or variable spring. The spring can take many forms such as by being a flat spring, a machined spring, and/or a serpentine spring. By way of nonlimiting examples, the springs can include various coil springs, pocket springs, Bonnell coils, offset coils, continuous coils, cantilever springs, volute springs, hairsprings, leaf springs, V-springs, gas springs, leaf springs, torsion springs, rubber bands, spring washers, and/or wave springs, to name just a few.

“Stator” generally refers to a stationary part or portion in a machine in or about which a rotating part revolves, which is commonly referred to as a rotor. The stator is the stationary part of a rotary system, such as found in electric generators, electric motors, sirens, mud motors, turbines, and/or biological rotors. In one particular non-limiting example, the stator includes the stationary portion of an electric generator and/or motor, especially of an induction motor.

“Steering System” generally refers to one or more devices and/or linkages that allow a vehicle to follow a desired course. By way of non-limiting examples, the steering system can include active, passive, rear wheel, front wheel, four-wheel, power, steer-by-wire, articulated, speed sensitive, differential, crab, hydraulic, rack and pinion, worm and sector, recirculating ball, Ackerman, and/or Bell-crank type systems, to name just a few.

“Sump” generally refers to a space that is configured to collect fluids from a device or system. A sump may be formed by a portion of a device or system, or a sump may be formed by a separate part that is attached to a device or system. For example, an oil pan on an engine or motor may be integrally formed with a housing of the engine or motor, or may be a separate part attached to the engine or motor. A sump is typically located on a bottom portion of a device in order to collect fluid that flows downward due to gravity. In some cases, a sump includes a pump that is configured to transport fluid from the sump to other parts of a device or system. In transmission systems, the term “upper sump” sometimes refers to locating the lubricant in a place other than in the sump.

“Suspension” generally refers to a type of mechanism that connects one or more wheels of a vehicle to a chassis or frame of the vehicle. Commonly, the suspension includes a network of springs, shock absorbers, and linkages that connect the wheels to the chassis. These parts of the suspension work in concert to absorb road shocks, maintain tire contact with the road surface for optimal traction and handling, and stabilize the vehicle by controlling body roll and unwanted movement. Suspensions can be categorized in a number of ways. For example, independent suspensions allow each wheel to move vertically without affecting the opposite wheel which offers enhanced ride quality and handling. Independent suspensions are commonly seen in modern cars using designs like MacPherson struts, double wishbones, or multi-link systems. Dependent suspensions, such as a solid axle suspensions, connect the wheels rigidly to the vehicle. In most road vehicles, the axle is connected to the chassis through a spring so as to create a live beam axle. A beam axle typically exists when there is a solid structure between both wheels such that the camber on one wheel is equivalent to the other wheel. Dependent suspensions provide robustness for heavy-duty applications like trucks and some sport utility vehicles (SUVs). Air suspensions use air springs instead of traditional metal springs so as to enable adjustable ride height and stiffness for enhanced comfort and load-carrying capacity. Air suspensions are often found in luxury vehicles and high-end SUVs. Hydraulic suspensions employ fluid-filled struts for self-leveling and for providing a relatively smooth ride. Leaf spring suspensions, which are a simpler dependent type design, are still used in some trucks and older vehicles for durability and load-bearing capabilities.

“Tire” generally refers to a toroidal or doughnut-shaped component of a wheel that encircles a rim of the wheel. The tire is configured to transfer the load of a vehicle to the ground or other driving surface and provide traction between the vehicle and the driving surface. Tires can be complex structures made from a variety of materials such as rubber, steel, and/or fabric. Some common types of tires include pneumatic, solid, semi-pneumatic, and foam-filled tires, to name just a few examples.

“Torque Converter” generally refers to a fluid and/or mechanical coupling device that transmits and amplifies torque from an engine to a rotating load. A hydraulic type torque converter uses a fluid medium to transfer power between the engine and the load. In some cases, the hydraulic torque allows for smooth power transfer and torque multiplication, especially at low speeds. Mechanical type torque converters are commonly in the form of a mechanical continuously variable transmission, a pendulum type torque converter, and a belt-pulley type drive.

“Transmission” generally refers to a power system that provides controlled application of mechanical power. The transmission uses gears and/or gear trains to provide speed, direction, and/or torque conversions from a rotating power source to another device.

“Vehicle” generally refers to a machine that transports people and/or cargo. Common vehicle types can include land-based vehicles, amphibious vehicles, watercraft, aircraft, and space craft. By way of non-limiting examples, land-based vehicles can include wagons, carts, scooters, bicycles, motorcycles, automobiles, vans, buses, trucks, semi-trailers, trains, trolleys, and trams. Amphibious vehicles can for example include hovercraft and duck boats, and watercraft can include ships, boats, and submarines, to name just a few examples. Common forms of aircraft include airplanes, helicopters, autogiros, and balloons, and spacecraft for instance can include rockets and rocket powered aircraft. The vehicle can have numerous types of power sources. For instance, the vehicle can be powered via human propulsion, electrically powered, powered via chemical combustion, nuclear powered, and/or solar powered. The direction, velocity, and operation of the vehicle can be human controlled, autonomously controlled, and/or semi-autonomously controlled. Examples of autonomously or semi-autonomously controlled vehicles include Automated Guided Vehicles (AGVs) and drones.

“Vehicle control system” generally refers to hardware and/or software responsible for issuing commands to various vehicle components. The components may activate steering, throttle, braking, or other operations related to vehicle movement. The vehicle components may also perform power distribution, energy storage, lighting, heating, cooling, monitoring, or communications among other functions. A vehicle control system may base commands on manual or automated inputs. A vehicle control system may also exchange information with the vehicle components.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### Reference Numbers

100 vehicle
105 powertrain system
110 electric axle
115 engine
120 e-machine
125 inverter
130 ESS
135 DC link
205 chassis
210 internal combustion engine
215 generator
220 fuel tank
225 battery
405 inverter
505 e-machine
510 transmission
515 shift actuator
520 ground clearance height
525 protection plate
600 hydraulics system
605 differential lock piston
610 sump tank
615 sump guard
620 dry sump tank
625 scavenger pumps
630 lubrication pump
632 mechanical drive
635 accumulator
640 electric pump
645 electric pump motor
1105 hydraulic valve
1205 piston cover
1405 anti-vortex covers
1410 suction pipes
1605 pipe openings
1805 cradle
1810 suspension
1815 upper suspension arm
1820 lower suspension arm
1825 bushings
1830 drive shaft
2005 spring
2010 damper
2012 mounting flanges
2015 stabilizer system
2020 steering system
2025 anti-roll bar
2305 anti-roll arms
2310 anti-roll drop links
2505 steering crossbar
2510 load point
2515 steering knuckle
2900 brake system
2905 rotor
2910 brake caliper
3305 spindle
3310 plain bearing
3315 suspension arm
3320 side plates
3325 fasteners
3330 washer
3335 cartridge seal
3340 fastener opening
3500 wheel assembly
3800 electric axle
3900 system
3905 electric axle
4300 system
4305 electric axle
4905 rear cover
4910 ECU
5100 assembly
5105 upright
5110 center spindle
5115 wheel end
5120 bolt on spindle
5125 bearing
5200 system
5205 first engine
5210 second engine
5215 first axle
5220 second axle
5225 third axle
5230 fourth axle
5235 e-machine
5240 transmission

What is claimed is:

1. A system, comprising:
an electric axle including a cradle;
wherein the electric axle includes an e-machine;
wherein the electric axle includes a transmission; and
wherein the cradle supports the e-machine and the transmission.

2. The system of claim 1, wherein:
the electric axle includes a suspension; and
the suspension is an independent suspension.

3. The system of claim 2, wherein the suspension is coupled to the cradle.

4. The system of claim 2, wherein:
the suspension includes a lower suspension arm and an upper suspension arm; and
the lower suspension arm and the upper suspension arm are pivotally coupled to the cradle.

5. The system of claim 4, further comprising:
one or more suspension bushings pivotally coupling the lower suspension arm and the upper suspension arm to the cradle.

6. The system of claim 4, further comprising:
a damper connected between the lower suspension arm and the cradle; and
a spring disposed between the lower suspension arm and the cradle.

7. The system of claim 6, wherein the spring is disposed around the damper.

8. The system of claim 4, wherein the suspension includes a stabilizer system.

9. The system of claim 8, wherein:
the stabilizer system includes an anti-roll bar;
the anti-roll bar is coupled to the cradle; and
the anti-roll bar extends across the electric axle to connect the suspensions at the opposing wheels of the electric axle.

10. The system of claim 9, wherein:
the anti-roll bar has anti-roll arms located at opposing ends of the anti-roll arm; and
the anti-roll arms are connected to the lower suspension arms via anti-roll drop links.

11. The system of claim 4, wherein the electric axle includes a steering system.

12. The system of claim 11, wherein the steering system includes a steering crossbar.

13. The system of claim 12, wherein the cross bar extends between the independent suspensions for the opposing wheels of the electric axle.

14. The system of claim 12, wherein the steering crossbar is coupled to the upper steering arm via a steering knuckle.

15. The system of claim 1, wherein the electric axle includes a brake system.

16. The system of claim 15, wherein the brake system includes inboard brakes.

17. The system of claim 15, wherein the brake system includes outboard brakes.

18. The system of claim 1, further comprising:
a chassis; and
wherein the cradle is connected to the chassis.

19. The system of claim 1, wherein:
the electric axle includes an inverter; and
the cradle supports in the inverter.

20. The system of claim 1, wherein the electric axle includes a hydraulics system.

21. The system of claim 20, wherein:
the hydraulics system includes a shifter; and
the shifter is configured to shift gears in the transmission.

22. The system of claim 20, wherein the hydraulics system includes a differential lock pin.

23. The system of claim 20, wherein:
the hydraulic system includes a sump tank;
the hydraulics system includes a dry sump tank;
the hydraulics system includes one or more scavenger pumps; and
the scavenger pumps are fluidly coupled between the sump tank and the dry sump tank.

24. The system of claim 23, wherein the hydraulics system includes a lubrication mechanical pump.

25. The system of claim 23, wherein the hydraulics system includes an accumulator.

26. The system of claim 23, wherein the hydraulics system includes one or more anti-vortex covers.

27. A system, comprising:
an electric axle including an e-machine;
wherein the electric axle includes a transmission;
wherein the electric axle includes a suspension; and
wherein the suspension is an independent suspension.

28. The system of claim 27, wherein the electric axle includes a cradle.
